(19) United States
(12) Patent Application Publication
(10) Pub. No.: US 2018/0206422 A1
(43) Pub. Date: Jul. 26, 2018

(54) INDUSTRIAL PLANT GROWING FACILITY AND METHODS OF USE

(71) Applicant: URBAN CROP SOLUTIONS BVBA, Beveren-Leie (BE)

(72) Inventor: Maarten VANDECRUYS, LEUVEN (BE)

(21) Appl. No.: 15/745,412

(22) PCT Filed: Jul. 17, 2015
(86) PCT No.: PCT/EP2015/066492

§ 371 Date: Jan. 16, 2018

(51) Int. Cl. A01G 31/06; A01G 7/04; A01G 22/15; F21V 3/00; F21V 23/00

(52) U.S. Cl. CPC A01G 31/06; A01G 7/045; A01G 22/60; F21V 3/00; F21V 23/003; A01G 22/15

(57) ABSTRACT

The invention is broadly in the agricultural field, more precisely in the field of industrial plant growth facilities. In particular, the invention concerns an industrial plant growing facility (100) for growing a variety of plants using predetermined growth conditions. Also, the invention concerns methods for growing plants in industrial plant growth facilities (100).

### FIELD OF THE INVENTION

The invention is broadly in the agricultural field, more precisely in the field of industrial plant growth facilities. In particular, the invention concerns an industrial plant growing facility for growing a variety of plants using predetermined growth conditions. Also, the invention concerns methods for growing plants in industrial plant growth facilities.

### BACKGROUND OF THE INVENTION

People consume the products and services of nature. Therefore, every individual has an impact on the planet. This impact is not problematic as long as the human load stays within the ecological capacity of the biosphere. The average ecological capacity can be calculated by dividing all the biologically productive land and sea on this planet by the number of people inhabiting. Presently, humanity has overloaded global biocapacity and is actively depleting stocks of natural capital. In order to decrease the production pressure on the current biologically productive land, more sustainable horticultural technologies need to be researched and developed.

Urban farming is an emerging sustainable horticultural technology. In urban farming, non-functional surface areas in urbanised regions are repurposed for horticulture. As urban farming is generally performed in environments which are isolated from the world's natural capital, farmers can better control spent resources and produced waste. Moreover, by working independently from local climates and the associated restrictions, the whole range of commercially exploitable crops can be cultivated in virtually any geographical environment.

However, current urban farming technologies generally have large operational costs because of non-efficient use of energy, manual labour, expensive installations and/or a small variety in crops. Therefore, there is a need for industrial plant production centres which allow the cultivation of a broad variety of plants. In addition, in high-labour cost countries, there is a need for mitigating high costs associated with manual labour.

In view of the above, there remains a need for further and/or improved industrial plant growing facilities.

### BRIEF DESCRIPTION OF THE DRAWINGS

The following description of the figures of specific embodiments of the invention is merely exemplary in nature and is not intended to limit the present teachings, their application or uses. Throughout the drawings, corresponding reference numerals indicate like or corresponding parts and features.

FIG. 1 shows an isometric view of an industrial plant growing facility (100) according to an embodiment of the present invention.

FIG. 2 shows a top-view of an industrial plant growing facility (100) according to an embodiment of the present invention.

FIG. 3 shows a side-view of an industrial plant growing facility (100) according to an embodiment of the present invention.

FIG. 4 shows a close-up of a part of an industrial plant growing facility according to an embodiment of the present invention.

In the figures, the following numbering is used:

100—industrial plant growing facility; 110—housing; 120—racks; 121—layer; 130—trays; 131—overflow; 135—plants; 141—nozzle; 142—drain; 160—LED-based lighting device; 200—transport system; 201—conveyor; 210—conveyor; 211—conveyor; 212—conveyor; 213—conveyor; 220—chain transfer device; 221—chain transfer device; 230—elevator; 231—elevator; 300—water- and nutrient reservoirs

### SUMMARY OF THE INVENTION

The present inventors have found an industrial plant growing facility which allows automation of the entire growth cycle, which has the flexibility to allow growth of a broad variety of plants, and which allows for creating multiple microclimates in one system, addressing one or more of the above-mentioned problems in the art.

Accordingly, a first aspect of the invention relates to an industrial plant growing facility for growing plants of at least one plant species comprising: a housing enclosing a growth chamber; a plurality of racks positioned in the growth chamber, wherein each rack is configured for receiving one or more trays; a plurality of trays placed in the plurality of racks, the plurality of trays being configured for receiving a plurality of plants of the at least one plant species, and the plurality of trays being configured for receiving a growth medium; a fluidic system configured for providing the trays with a growth medium comprising nutrients and having a pH, wherein the fluidic system is configured for adapting the nutrient concentration and pH according to a predetermined nutrient concentration and predetermined pH for the plant species; a climate system configured for providing a temperature and humidity within the growth chamber, wherein the climate system is configured for adapting the temperature and humidity within the growth chamber according to a predetermined temperature and predetermined humidity for the plant species; a plurality of light-emitting diode (LED)-based lighting devices configured for providing a light spectrum and a light intensity, wherein the light spectrum comprises photosynthetically active radiation (PAR); and wherein the LED-based lighting devices are configured for adapting the light intensity and/or light spectrum according to a predetermined light intensity and/or predetermined light spectrum for the plant species; a carbon dioxide system configured for providing a carbon dioxide concentration within the growth chamber, wherein the carbon dioxide system is configured for adapting the carbon dioxide concentration according to a predetermined carbon dioxide concentration for the plant species; and a transport system for transporting the trays.

The industrial plant growing facility illustrating the present invention allows for automatic microclimate control, thereby allowing automation of the entire growth cycle of a plant such as a crop, up until harvest of the full grown plant. Furthermore, the industrial plant growing facility has the flexibility to allow serially and concomitantly growing a broad variety of plants such as leafy greens, herbs, halophytes, and medicinal plants in an efficient and cost-effective manner. Also, the present industrial plant growing facility allows growing plants of diverse plant species, such as different crops, in one system or facility, obviating the need for transport between separate facilities or the need for compartmentalization. In addition, the present industrial plant growing facility allows growing plants independently from climatological conditions and independently from the presence of natural light, thereby allowing plant growth in urban areas, for instance in non-functional surface areas in urbanized regions.

In a further aspect, the present invention relates to a LED-based lighting device for an industrial plant growing facility comprising at least a UV LED, a blue LED, a green LED, and a red LED;
the UV LED being configured for emitting light having a wavelength of at least 100 nm to at most 400 nm, preferably for emitting light having a wavelength of at least 300 nm to at most 350 nm;
the blue LED being configured for emitting light having a wavelength of at least 400 nm to at most 490 nm, preferably for emitting light having a wavelength of at least 450 nm to at most 490 nm;
the green LED being configured for emitting light having a wavelength of at least 490 nm to at most 570 nm, preferably for emitting light having a wavelength of at least 500 nm to at most 520 nm; and
the red LED being configured for emitting light having a wavelength of at least 570 nm to at most 700 nm, preferably for emitting light having a wavelength of at least 600 nm to at most 650 nm;
   wherein the LED-based lighting device is configured for adapting the light intensity and/or light spectrum emitted by the UV LED, the blue LED, the green LED, and the red LED according to a predetermined light intensity and/or light spectrum.

The light intensity emitted by the various LEDs may be changed proportionally. By proportionally changing the light intensity emitted by the various LEDs, the light intensity emitted by the LED-based lighting device may be changed without changing the light spectrum emitted by the LED-based lighting device. The light intensity emitted by the various LEDs may be changed independently. By independently changing the light intensity emitted by the various LEDs, the light spectrum emitted by the LED-based lighting device might be adapted.

Such a tuneable broad LED set-up may allow enhancing cost- and energy efficiency by using the most efficient light treatments for different crop species. Providing such LED-based lighting devices of which the light spectrum and light intensity may be adapted, advantageously allow improving plant growth efficiency by facilitating provision of optimal light spectrum and intensity for plants of certain plant species and in certain stages of growth. In addition, light intensity and light spectrum may be adapted for influencing particular plant properties, for example light intensity and light spectrum may be adapted for increasing the nutritional value of plants. Moreover, compared to other lighting devices, the present LED-based lighting devices allow providing higher energy efficiency. The LED-based lighting devices illustrating the principles of the present invention may enhance an industrial plant growing facility's overall cost- and energy efficiency.

In a further aspect, the present invention relates to a method for growing plants of at least one plant species, comprising the steps of:
(a) providing an industrial plant growing facility as taught herein;
(b) placing a tray comprising seeds of the at least one plant species in the growth chamber;
(c) growing the seeds into mature plants, thereby obtaining mature plants; and,
(d) removing the tray comprising the mature plants out of the growth chamber,
   wherein during step (c) the nutrient concentration, the pH, the temperature, the humidity, the light spectrum, the light intensity, the carbon dioxide concentration, and optionally the vertical inter-tray distance, are adapted to a predetermined nutrient concentration, a predetermined pH, a predetermined temperature, a predetermined humidity, a predetermined light spectrum, a predetermined light intensity, a predetermined carbon dioxide concentration, and optionally a predetermined vertical inter-tray distance, determined by the plant species. The present method allows growing plants in an energy-efficient, nutrient-efficient way in small spaces. In particular, the present method for growing plants may provide flexibility for growing plants under any given climate condition and any given day of the year without interrupting the plant growth process. Furthermore, the method allows to grow serially and concomitantly a broad variety of plants such as leafy greens, herbs, halophytes, and medicinal plants.

In a further aspect, the present invention provides the use of an industrial plant growing facility as taught herein for growing leafy greens, herbs, halophytes and/or medicinal plants. This allows growing leafy greens, herbs, halophytes and/or medicinal plants in an energy-efficient, nutrient-efficient way in small spaces. In particular, the present industrial plant growing facility may provide flexibility and variability of plants, for example crops, that can be cultivated in the facility. The present industrial plant production centre (IPPC) may provide an automatized, closed, controllable, energy-efficient and clean environment useful for growing plants.

In a further aspect, the present invention provides the use of a LED-based lighting device as taught herein for growing leafy greens, herbs, halophytes and/or medicinal plants. This allows growing leafy greens, herbs, halophytes and/or medicinal plants in an energy-efficient, nutrient-efficient way in small spaces. In particular, the present industrial plant growing facility shows the flexibility and variability of using tuneable LED lights in order to cultivate a wide range of crops in a fully controllable facility.

The above and further aspects and preferred embodiments of the invention are described in the following sections and in the appended claims. The subject-matter of appended claims is hereby specifically incorporated in this specification.

### DETAILED DESCRIPTION OF THE INVENTION

As used herein, the singular forms “a”, “an”, and “the” include both singular and plural referents unless the context clearly dictates otherwise.

The terms “comprising”, “comprises” and “comprised of” as used herein are synonymous with “including”, “includes” or “containing”, “contains”, and are inclusive or open-ended and do not exclude additional, non-recited members, elements or method steps. The terms also encompass “consisting of” and “consisting essentially of”.

The recitation of numerical ranges by endpoints includes all numbers and fractions subsumed within the respective ranges, as well as the recited endpoints.

The term “about” as used herein when referring to a measurable value such as a parameter, an amount, a temporal duration, and the like, is meant to encompass variations of and from the specified value, in particular variations of +/−10% or less, preferably +/−5% or less, more preferably +/−1% or less, and still more preferably +/−0.1% or less of and from the specified value, insofar such variations are appropriate to perform in the disclosed invention. It is to be understood that the value to which the modifier “about” refers is itself also specifically, and preferably, disclosed.

Whereas the term “one or more”, such as one or more members of a group of members, is clear per se, by means of further exemplification, the term encompasses inter alia a reference to any one of said members, or to any two or more of said members, such as, e.g., any ≥3, ≥4, ≥5, ≥6 or ≥7 etc. of said members, and up to all said members.

All documents cited in the present specification are hereby incorporated by reference in their entirety.

Unless otherwise specified, all terms used in disclosing the invention, including technical and scientific terms, have the meaning as commonly understood by one of ordinary skill in the art to which this invention belongs. By means of further guidance, term definitions may be included to better appreciate the teaching of the present invention.

The present inventors have devised an industrial plant growing facility. The industrial plant growing facility may include climate control, automation, flexible shelf height, and light-emitting-diode (LED)-base lighting devices. The industrial plant growing facility may allow growing a large variety of crops in a cost-effective and energy efficient way.

The terms “industrial plant growing facility”, “industrial plant growth facility”, “industrial plant production centre (IPPC)” may be used interchangeably herein.

The industrial plant growing facility as taught herein comprises a housing enclosing a growth chamber. The housing forms a physical barrier which shields the one or more microclimates in the industrial plant growing facility from adverse atmospheric influences which may include harsh climate, unsuitable irradiance, unsuitable radiation spectrum, pathogens, parasites and/or parasitoids.

The industrial plant growing facility as taught herein comprises a plurality of racks positioned in the growth chamber, wherein each rack is configured for receiving one or more trays. A plurality of trays may be placed in the plurality of racks, the plurality of trays being configured for receiving a plurality of plants of the at least one plant species, and the plurality of trays being configured for receiving a growth medium. By using plant growth trays in racks, the racks being vertically stacked, a significantly increased arable surface per unit area may be obtained compared to a facility or system in which only one layer is used. This may be especially efficient for locally producing crops in space-constrained regions such as big cities.

The industrial plant growth facility provided herein includes a housing enclosing a growth chamber and a plurality of racks, the plurality of racks being positioned in the growth chamber, and the plurality of racks being configured for receiving one or more trays.

Preferably each rack is configured for receiving two or more trays, for example 3, 4, 5, 6, 7, 8, or 9 trays.

A plurality of trays may be placed in the racks. The trays are configured for receiving a plurality of seeds and/or plants of at least one plant species. Furthermore, the trays are configured for receiving a growth medium. Also, the trays are configured for applying the growth medium to the seeds and/or plants. The growth medium is delivered to the trays by means of a fluidic system. The growth medium comprises nutrients and has a pH. The growth medium's nutrient concentration and pH value are controlled by means of a control unit, for example a programmable logic controller (PLC).

The industrial plant growing facility as taught herein comprises a fluidic system configured for providing the trays with a growth medium comprising nutrients and having a pH, wherein the fluidic system is configured for adapting the nutrient concentration and pH according to a predetermined nutrient concentration and predetermined pH for the plant species. The fluidic system facilitates nutrient efficiency optimization. Furthermore, the use of a controllable nutrient supply and pH regulator allows controlling the supply of nutrients, whereby the supply of nutrients is preferably adapted to the nutrient uptake of the plants being grown in the growth chamber. Moreover, nutrient control under different plant developmental stages may provide flexibility for responding in an efficient way to plant needs. This may result in better yields by providing the necessary nutrients that the plants need to grow with a correct water/nutrient management.

The industrial plant growing facility as taught herein comprises a climate system configured for providing a temperature and humidity within the growth chamber. The climate system is configured for adapting the temperature and humidity within the growth chamber according to predetermined values of temperature and humidity for the plants and/or seeds of the at least one plant species being grown in the industrial plant growing facility. In particular embodiments, the predetermined temperature and predetermined humidity may be adapted to the stages of plant growth for the plant species. The climate system facilitates energy efficiency optimization. Furthermore, the use of a controllable climate system (i.e., a system for controlling temperature and humidity) allows providing optimal environmental conditions in the system for plants of specific plant species.

Preferably, temperature and humidity are adapted to predetermined values, the predetermined values preferably being chosen to correspond to optimum growth conditions for the plants being grown.

The industrial plant growing facility as taught herein comprises a plurality of LED-based lighting devices configured for providing a light spectrum and a light intensity, wherein the light spectrum comprises PAR; and wherein the LED-based lighting devices are configured for adapting the light intensity and/or light spectrum according to a predetermined light intensity and/or predetermined light spectrum for the plant species.

The LED-based lighting devices further help energy efficiency optimization. In particular, LED-based lighting devices may be configured for providing the optimum amount of PAR which plants need for growing. Moreover, compared to conventional lighting devices, LED-based lighting devices may provide enhanced energy efficiency. Accordingly, improved yield and enhanced energy efficiency may be obtained by providing the optimum amount of PAR which plants need for growing.

The industrial plant growing facility as taught herein comprises a carbon dioxide (CO₂) system configured for providing a carbon dioxide concentration within the growth chamber. Preferably, the carbon dioxide system is configured for adapting the carbon dioxide concentration in the growth camber according to a predetermined carbon dioxide concentration for the plant species being grown in the growth chamber. The carbon dioxide system also contributes to energy efficiency optimization. In particular, controlling the CO₂ concentration in the growth chamber may improve photosynthetic system of the plants being cultivated. Moreover the ability to control CO₂ in a closed environment gives the flexibility to deliver the optimal dose to the plant optimizing the energy used.

The industrial plant growing facility as taught herein further comprises a transport system for transporting the trays. The transport system may transport the trays inside the growth chamber of the IPPC. The transport system may transport the trays between different positions within one layer of the IPPC, or the transport system may transport the trays from one layer to another layer of the IPPC.

In certain embodiments, the industrial plant growing facility as taught herein may comprise a transport system for transporting the trays, wherein the transport system is configured for placing the trays in the growth chamber and for removing the trays out of the growth chamber. The transport system allows increasing the industrial plant growing facility's cost efficiency, especially in industrialized countries with high labour costs. The transport system may enhance human labour efficiency of tray transport as well as the clean environment inside the system. This may result into a cost efficient harvest in a clean environment.

In certain embodiments, the trays may be loaded or placed in the growth chamber and removed out of the growth chamber manually, by means of a lifting mast, and/or by means of an elevator.

In certain preferred embodiments, the trays may be loaded or placed in the growth chamber and/or removed out of the growth chamber by means of a lifting mast. In certain embodiments, the industrial plant growing facility as taught herein may comprise a transport system for transporting the trays, wherein the transport system comprises a lifting mast configured for placing the trays in the growth chamber and for removing the trays out of the growth chamber. A lifting mast advantageously allows moving the trays between different layers of the industrial plant growing facility, while being cost-efficient.

In certain embodiments, the trays may be loaded or placed in the growth chamber and/or removed out of the growth chamber by means of an (automatic) elevator. In certain embodiments, the industrial plant growing facility as taught herein may comprise a transport system for transporting the trays, wherein the transport system comprises an elevator configured for placing the trays in the growth chamber and for removing the trays out of the growth chamber.

The choice of the transport system, such as manually, lifting mast, or elevator, may depend on the purpose and size of the industrial plant growing facility (e.g., manually for small IPPC, mast for medium IPPC, or elevator for large IPPC).

Certain embodiments further provide a plant growing facility for growing plants of at least one plant species comprising:
a housing enclosing a growth chamber;
a plurality of racks positioned in the growth chamber, wherein each rack is configured for receiving one or more trays;
a plurality of trays placed in the plurality of racks, the plurality of trays being configured for receiving a plurality of plants of the at least one plant species, the plurality of trays being configured for receiving a growth medium, and preferably the trays being spaced by (i.e., the trays having an vertical inter-tray distance of) at least 5 cm to at most 80 cm;
a fluidic system configured for providing the trays with a growth medium comprising nutrients and having a pH, wherein the fluidic system is configured for adapting the nutrient concentration and pH according to a predetermined nutrient concentration and predetermined pH for the plant species, the fluidic system preferably being configured for controlling the pH of the growth medium between at least 5.5 to at most 8.0, and preferably the fluidic system being configured for controlling the electrical conductivity of the nutrient solution between at least 1.5 and at most 4.0 mS/cm;
a climate system configured for providing a temperature and humidity within the growth chamber, wherein the climate system is configured for adapting the temperature and humidity within the growth chamber according to a predetermined temperature and predetermined humidity for the plant species, and preferably the climate system being configured for controlling the humidity between at least 70% and at most 80%;
a plurality of LED-based lighting devices configured for providing a light spectrum and/or a light intensity, wherein the light spectrum comprises photosynthetically active radiation; and wherein the LED-based lighting devices are configured for adapting the light intensity and/or light spectrum according to a predetermined light intensity and/or predetermined light spectrum for the plant species;
a carbon dioxide system configured for providing a carbon dioxide concentration within the growth chamber, wherein the carbon dioxide system is configured for adapting the carbon dioxide concentration according to a predetermined carbon dioxide concentration for the plant species, preferably the carbon dioxide system being configured for controlling the carbon dioxide concentration between at least 500 ppm to at most 1200 ppm; and,
a transport system for transporting the trays, preferably wherein the transport system is configured for placing the trays in the growth chamber and for removing the trays out of the growth chamber.

Industrial plant growth facilities provided herein may offer increased yields at lower costs compared to State-of-the-Art systems.

In particular embodiments, the trays are spaced by at least 5 cm to at most 80 cm, for example 10 cm, for example 20 cm, for example 30 cm, for example 40 cm, for example 50 cm, for example 60 cm, for example 70 cm.

In particular embodiments, the fluidic system may be configured for controlling the electrical conductivity of the nutrient solution between at least 1.0 mS/cm and at most 4.0 mS/cm, for example 2.5 mS/cm.

In particular embodiments, the climate system may be configured for controlling the humidity between at least 70% and at most 80%, for example 75%.

In particular embodiments, the carbon dioxide system may be configured for controlling the carbon dioxide concentration between at least 500 ppm to at most 1200 ppm, for example 750 ppm.

In certain embodiments, the industrial plant growing facility may be configured for adapting one or more growth conditions during one or more stages of plant growth;
the one or more growth conditions being chosen from the list comprising: inter-tray distance, (growth medium) pH, (growth medium) nutrient concentration, temperature, humidity, light spectrum, light intensity, and CO₂ concentration; and,
the one or more stages of plant growth comprising germination stage and/or seedling-to-harvest stage; the germination stage preferably lasting at least two days to at most three weeks, and the seedling-to-harvest stage preferably lasting at least 11 days to at most 713 days, more preferably at least 20 days to at most 100 days, for example 50 days.

In particular embodiments, the transport system is an automated transport system. This may be particularly advantageous when the industrial plant growing facility is used in an industrialized country with relatively high wage costs. An exemplary embodiment of a method for growing plants in an industrial plant growing facility as taught herein using an automated transport system is provided in the examples.

In particular embodiments, the transport system is a transport system comprising substantial manual labour. This may be particularly advantageous in countries with relatively low wage costs.

In particular embodiments, the vertical inter-tray distance is adaptable according to plant height. In some embodiments, the vertical distance between the trays may be adjusted, preferably adjusted based on plant needs, by means of mounting the trays on vertical screw threads, and using a motorized connection. As such, the height of layers formed by a plurality of laterally displaced trays may be adjusted, preferably adjusted according to plant needs, by means of the vertical screw threads and the motorized connection.

Preferably, the vertical inter-tray distance is adaptable according to plant height. Each tray is preferably provided with a similar nutrient composition and nutrient concentration; though in particular embodiments, nutrient composition and/or nutrient concentration may vary from tray to tray, or from layer to layer.

The vertical inter-tray distance may be fixed, though varying throughout the industrial plant growth facility. Alternatively, the vertical inter-tray distance may be changed manually. Alternatively, the vertical inter-tray distance may be changed in an automated way.

The recitation “vertical distance between trays” or “vertical inter-tray distance” refers to the shortest distance in the vertical direction (along the height of a rack) between trays positioned in the industrial plant growing facility.

Thus, larger plants may be grown on trays having a larger vertical inter-tray distance compared to smaller plants. This may be advantageous when growing different plants having different heights in one industrial plant growth facility. In addition, this may be advantageous for optimal space use when the height of the plants differs significantly during different stages of plant growth, younger plants generally being smaller than older plants.

In particular embodiments, the vertical inter-tray distance may be from about 5 cm to about 80 cm. For instance, the vertical inter-tray distance may be from about 10 cm to about 60 cm, from about 15 cm to about 60 cm, from about 20 cm to about 60 cm, from about 15 cm to about 50 cm, from about 20 cm to about 50 cm, or from about 20 cm to about 40 cm.

In particular embodiments, the vertical inter-tray distance may vary. In particular embodiments, the vertical inter-tray distance may increase with increasing height of the rack (i.e., lower vertical inter-tray distance at the bottom of the rack and higher vertical inter-tray distance at the top of the rack). In particular embodiments, the vertical inter-tray distance may decrease with increasing height of the rack (with higher vertical inter-tray distance at the bottom of the rack and lower vertical inter-tray distance at the top of the rack). In particular embodiments, the vertical inter-tray distance may oscillate with increasing height of the rack. As mentioned before, larger plants may be grown on trays having a larger vertical inter-tray distance compared to smaller plants. Again, this may be advantageous for optimal space use in the present industrial plant growth facilities.

In particular embodiments, the vertical inter-tray distance may increase from about 20 cm near the lower layers of trays to about 40 cm near the upper layers of trays. For example, an industrial plant growth facility as taught herein may comprise racks comprising 10 layers of trays, wherein the vertical inter-tray distance is three times 20 cm, three times 30 cm, and three times 40 cm, with increasing height of the rack. Alternatively, in particular embodiments, the vertical inter-tray distance decreases from about 40 cm near the lower layers of trays to about 20 cm near the upper layers of trays. For example, an industrial plant growth facility provided herein may comprise racks comprising 8 layers of trays, wherein the vertical inter-tray distance is two times 40 cm, two times 30 cm, and three times 20 cm, with increasing height of the rack.

Preferably, the racks and/or the trays comprise a plurality of CO₂ sensors. Preferably, the plurality of CO₂ sensors is distributed uniformly throughout the industrial plant growth facility. Sensing the CO₂ the CO₂ concentration throughout the industrial plant growth facility may be advantageous for CO₂ concentration control.

Preferably, a humidifier and/or a dehumidifier is provided with the industrial plant growing facility. Preferably, moisture sensors are distributed in the racks. This may allow effective humidity control in the growth chamber.

Preferably, CO₂ is stored in-situ in a cistern. Preferably, the racks are provided with distributed CO₂ sensors. This may allow effective CO₂ concentration control in the growth chamber.

In certain embodiments, the industrial plant growing facility may further comprise a ventilation system. The ventilation system may comprise pressurized air pumps. By using pressurised air pumps and assuring no air escapes from (the sides of) the system, a homogeneous airflow may be created. In certain embodiments, the industrial plant growing facility may comprise a ventilation system configured for providing an air flow within the growth chamber, wherein the ventilation system is configured for adapting the air flow within the growth chamber according to a predetermined air flow for the plant species.

The terms “air flow”, “air speed”, or “air stream” may be used interchangeably. The industrial plant growth facility may comprise a control unit for receiving inputs and providing outputs. The inputs may be chosen from the list comprising: kind of crop, pH, CO₂, temperature, humidity, electrical conductivity (EC) and air current. The outputs may be chosen from the list comprising: addition of one or more nutrients and/or nutrient compositions to the growth medium, addition of water to the growth medium, draining growth medium, addition of acids to the growth medium, addition of bases to the growth medium, reconfiguring the cooling system, reconfiguring the heating system, pumps, reconfiguring growth conditions, and changing the power supplied to one or more ventilators. In particular, the control unit may comprise a programmable logic controller. Also provided herein is a control unit configured for adapting growth conditions to predetermined values of parameters in an industrial plant growing facility provided herein. An exemplary embodiment of such a control unit is provided in example 6. The control unit may be a PLC controller.

In particular embodiments, the control unit may be configured for operationally coupling with a computer-readable storage medium such as a flash drive or a non-volatile magnetic storage medium. In this way, the control unit may be readily adapted to new growth conditions.

In particular embodiments, the control unit may be operationally coupled to one or more ventilators, the ventilators being configured for providing an air stream throughout the growth chamber or a part thereof. Preferably, the air stream is a constant air stream. The presence of an air stream in the growth chamber may aid achieving homogeneous growth conditions in the growth chamber and/or parts thereof.

In particular embodiments, water and nutrients comprised in the growing medium which are not absorbed by the plants are drained as effluent. Preferably, the effluent is recycled as growth medium. When the effluent is recycled as growth medium, its composition is preferably enriched by adding suitable amounts of nutrients and/or water.

The suitable amount of nutrients and/or water is preferably determined by means of the following procedure: the effluent is analyzed, and the analyzed data are compared to suitable growing medium compositions for particular plants. Based on the analysis and the suitable growing medium compositions, nutrients and/or water are added to the effluent, turning the effluent into a suitable growth medium. This procedure prevents accumulation of non-absorbed nutrients in the effluent recycled growth medium by adapting addition of nutrients and/or water to actual plant uptake.

The effluent may be disinfected prior to recycling.

In particular, the effluent from a closed environment system may be recycled in the industrial plant growth facility as long as the environment has been kept under optimal sanitary conditions and the water parameters have not been changed from the optimal conditions. Additional nutrients may be added to the effluent prior to recycling to counteract depletion of particular nutrients by plant uptake. Moreover, the effluent may be disinfected and/or filtered prior to adding additional nutrients.

In particular embodiments, when the industrial plant growing facility is configured for growing leafy greens, for example lollo bionda, spinach, or watercress; the industrial plant growing facility is configured for providing a predetermined day temperature of about 20° C., a predetermined night temperature of about 16° C., a predetermined day length of about 18 h, a predetermined night length of about 6 hours, a predetermined light intensity (PAR) of about 300 μmol·m⁻²·s⁻¹, a predetermined humidity of about 80%, a predetermined CO₂ concentration of about 1200 ppm, a predetermined air flow of at least 0.2 m/s to at most 0.5 m/s, and a predetermined pH of at least 5.5 to at most 7.5; and providing an aqueous growth medium, the aqueous growth medium comprising nutrients at a predetermined nutrient concentration of at least 10 mg/l to at most 18 mg/l nitrogen, at least 6.0 mg/l to at most 15 mg/l phosphorous, at least 4.0 mg/l to at most 18 mg/l potassium, at least 23 mg/l to at most 84 mg/l calcium, at least 4.0 mg/l to at most 24 mg/l magnesium, and at least 0.9 mg/l to at most 1.0 mg/l iron. In certain embodiments, during germination stage, the industrial plant growing facility is configured for providing a predetermined light spectrum of far-red LED, blue LED, green LED, and red LED. In certain embodiments, during seedling-to-harvest stage, the industrial plant growing facility is configured for providing a predetermined light spectrum of UV LED, blue LED, green LED, red LED, and far-red LED.

In particular embodiments, when the industrial plant growth facility is configured for growing herbs, for example basil, chive, or coriander, the industrial plant growth facility is configured for providing a predetermined day temperature of at least 20° C. to at most 26° C., a predetermined night temperature of at least 16° C. to at most 21° C., a predetermined day length of about 18 hours, a predetermined light intensity (PAR) of about 300 μmol·m⁻²·s⁻¹, a predetermined humidity of about 80%, a CO₂ concentration of about 1000 ppm, a predetermined air flow of about 0.2 m/s, and a predetermined pH of at least 5.5 to at most 7.0; and providing an aqueous growth medium, the aqueous growth medium comprising nutrients at a predetermined nutrient concentration of at least 15 mg/l to at most 25 mg/l nitrogen, at least 11 mg/l to at most 15 mg/l phosphorous, at least 11 mg/l to at most 15 mg/l potassium, at least 50 mg/l to at most 90 mg/l calcium, at least 24 mg/l to at most 42 mg/l magnesium, and at least 1.8 mg/l to at most 2.5 mg/l iron. In certain embodiments, during germination stage, the industrial plant growing facility is configured for providing a predetermined light spectrum of far-red LED, blue LED, green LED, and red LED. In certain embodiments, during seedling-to-harvest stage, the industrial plant growing facility is configured for providing a predetermined light spectrum of UV LED, blue LED, green LED, red LED, and far-red LED.

In particular embodiments, when the industrial plant growing facility is configured for growing halophytes, such as Salicornia, salsola, or sea aster, the industrial plant growing facility is configured for providing a day temperature of at least 25° C. to at most 26° C., providing a predetermined night temperature of at least 15° C. to at most 20° C., providing a predetermined day length of about 18 hours, providing a predetermined night length of about 6 hours, providing a predetermined light intensity (PAR) of about 200 μmol·m⁻²·s⁻¹, a predetermined humidity of at least 60% to at most 70%, a predetermined CO₂ concentration of about 800 ppm, a predetermined air flow of about 0.6 m/s, and a predetermined pH of at least 5.5 to at most 7.0; and further providing an aqueous growth medium comprising nutrients at a predetermined nutrient concentration of about 4.0 mg/l nitrogen, at least 5.0 mg/l to at most 6.0 mg/l phosphorous, at least 6.0 mg/l to at most 8.0 mg/l potassium, at least 40 mg/l to at most 50 mg/l calcium, at least 12 mg/l to at most 24 mg/l magnesium, at least 1.0 mg/l to at most 1.2 mg/l iron, and about 300 mg/l sodium. In certain embodiments, during germination stage, the industrial plant growing facility is configured for providing a predetermined light spectrum of far-red LED, blue LED, green LED, and red LED. In certain embodiments, during seedling-to-harvest stage, the industrial plant growing facility is configured for providing a predetermined light spectrum of far-red LED, blue LED, green LED, and red LED.

Certain embodiments further provide an industrial plant growing facility for growing plant species comprising:
a housing enclosing a growth chamber;
a plurality of racks, the plurality of racks being positioned in the growth chamber;
a plurality of trays, the plurality of trays being placed in the plurality of racks, the vertical distance between the trays being adaptable, the plurality of trays being configured for receiving a plurality of plants, and the plurality of trays being configured for receiving a growth medium for providing nutrients and moisture to the plants;
a fluidic system configured for providing the trays with growth medium, the fluidic system being operationally coupled with the trays, and the fluidic system being configured for adapting the nutrient concentration during plant growth according to the needs of the plants at the different stages of plant growth;
a climate controller configured for providing a homogeneous temperature and humidity within one or more parts of the growth chamber, thereby creating a microclimate in the one or more parts of the growth chamber, and the climate controller being configured for adapting the microclimate according to the needs of the plants at the different stages of plant growth;
a plurality of LED-based lighting devices configured for providing a light intensity and/or light spectrum, wherein the adaptable light spectrum comprises PAR; and the plurality of LED-based lighting devices being configured for adapting the light intensity and/or light spectrum during plant growth based on the needs of the plant at the different stages of plant growth,
a carbon dioxide concentration controller configured for adapting the carbon dioxide concentration during plant growth based on the needs of the plants at the different stages of plant growth;
a transport system for transporting plant growth trays, wherein the transport system is configured for placing trays comprising plant seeds in the industrial plant growing facility and for removing trays comprising mature plants out of the industrial plant growing facility.

The different stages of plant growth may comprise germination and vegetative growth. The terms “germination”, “germination stage”, “seed-to-seedling”, or “seed to seedling” may be used interchangeably herein and generally refer to the stage of plant growth wherein a seed develops into a seedling.

The growth stage “vegetative growth” may be subdivided in two or more substages, such as for instance seedling to adult plant and adult plant to harvest plant. Preferably, the growth stage “vegetative growth” is subdivided in three or four substages, such as for instance seedling to adult plant, adult plant to flowering, and flowering to harvest plant.

The terms “vegetative growth”, “seedling-to-harvest”, “seedling to harvest” or “seedling-to-harvest stage” may be used interchangeably herein and generally refer to the stage of plant growth wherein a seedling develops into a harvest plant.

The number of substages typically depends on plant species. Growth conditions may vary from one substage to the other, according to predetermined parameters.

In the case of flowering plants (medicinal plants), the growth stages may be selected from the list comprising: 1) seed to seedling; 2) seedling to adult plant; 3) adult plant to flowering; and 4) flowering to harvest plant.

In the case of vegetables and herbs, the growth stages may be selected from the list comprising: 1) seed to seedling; 2) seedling to adult plant; 3) adult plant to harvest plant. In some cases, herbs can be harvested by cutting and regrow (second harvest) can be made, which may be considered as a fourth stage.

In particular embodiments, the fluidic system is configured for adding one or more nutrients and/or increasing the concentration of one or more nutrients during the last stages of plant growth. This may increase plant yield, enhance plant nutritional value, enhance the concentration of active ingredients in the plants, and/or may enhance the taste of plants.

Increasing the concentration of specific nutrients such as N, K, and Ca can result in the increase of vitamin C and phenolic compounds in some lettuce varieties.

In particular embodiments, the LED-based lighting device is configured for adapting the light spectrum during the growth cycle. The process of “adapting the light spectrum during the growth cycle” may comprise providing extra UV light during the last stage of plant growth. This may enhance plant properties. In particular, treatments with Red, Blue, and UV-A LED radiation; as well as Red, Green and Blue LED irradiation during the vegetative stages could increase the shoot fresh mass and lower nitrate content in different varieties of lettuces.

Preferably, the industrial plant growing facility is used for growing plants from seed to mature plant.

In particular embodiments, the industrial plant growing facility may comprise an oxygen system for providing an oxygen concentration, wherein the oxygen system is configured for adapting the oxygen concentration according to predetermined value of the oxygen concentration. Preferably, the oxygen concentration is adapted during plant growth based on predetermined values of the oxygen concentration at the different stages of plant growth.

In particular embodiments, the industrial plant growing facility may comprise a transport system for transporting plant growth trays, wherein the transport system is configured for placing trays comprising plant immature plants in the industrial plant growing facility and for removing trays comprising mature plants out of the industrial plant growing facility.

The term “immature plants” as used herein refers to plants and/or plant parts which are not intended to be harvested. In particular, the term “immature plants” may include seeds, seedlings, and sprouts, provided that these plants are not intended to be harvested.

The term “mature plants” as used herein refers to plants and/or plant parts which are intended to be harvested, such as harvest plants. In particular, the term “mature plants” may include seeds, seedlings, sprouts, and adult plants provided that these plants and/or plant parts are intended to be harvested.

The term “growth conditions” as used herein refers to a set of conditions, described by a plurality of parameters, adapted to growing specific plant species and/or specific plants at different stages of growth. The parameters may be chosen from the list comprising: the vertical inter-tray distance, the nutrient concentration, the pH, the temperature, the humidity, the light spectrum, the light intensity, the CO₂ concentration, and the air flow.

The term “housing” as used herein refers to an enclosure around the growth chamber for isolating the growth chamber from atmospheric conditions.

The term “rack” as used herein refers to a device for holding trays. In addition, a rack may be configured for supporting a fluidic system or parts thereof, carbon dioxide sensors, humidity sensor, and/or air flow sensors.

The term “tray” as used herein refers to a device for holding plants and a growth medium. A tray is configured for providing growth medium to the roots of plants. In addition, a tray is configured for exposing the foliage of plants to the gas in the growth chamber. An exemplary tray is provided in FIG. 4.

Preferably, the gas in the growth chamber resembles atmospheric air, more preferably the gas in the growth chamber has a higher carbon dioxide concentration compared to atmospheric air.

The term “growth medium” as used herein refers to an aqueous solution for growing plants comprising nutrients chosen from the list comprising nitrogen, phosphorous, potassium, calcium, magnesium, iron, sulphur, manganese, boron, copper, zinc, molybdenum, silica, and sodium.

The term “fluidic system” as used herein refers to a system for applying growth medium to the roots of plants, and for draining excess spent growth medium. Preferably, the fluidic system is also configured for recycling excess spent growth medium. A fluidic system comprises a set of interconnected reservoirs, supply tubes, and drains.

The term “climate system” as used herein refers to a set of operationally coupled components comprising temperature sensors, heating elements and cooling elements configured for controlling the temperature in the growth chamber.

The term “LED-based lighting device” as used herein refers to a lighting device comprising a plurality of light emitting diodes (LEDs), the LED-based lighting device being configured for emitting electromagnetic radiation in the photosynthetically active radiation (PAR) range. Preferably, the LED-based lighting device is also configured for emitting electromagnetic radiation around the PAR range.

The term “carbon dioxide system” as used herein refers to a system configured for controlling the carbon dioxide concentration in the growth chamber. The carbon dioxide system comprises a set of operationally coupled components comprising a control unit, a carbon dioxide sensor, and a carbon dioxide source. The carbon dioxide source may be a cistern comprising liquid carbon dioxide. Alternatively, the carbon dioxide source may be a gas burner, the latter being particularly advantageous in colder climates wherein the industrial plant growth facility needs to be heated.

The term “transport system” as used herein refers to a system for transporting trays around the industrial plant growing facility. Preferably, the transport system is also configured for moving trays comprising seeds, seedlings, and/or immature plants into the industrial plant growth facility. Preferably, the transport system is also configured for moving trays comprising mature plants out of the industrial plant growth facility.

In particular embodiments, the industrial plant growth facility may be configured for adapting the vertical distance between the LED-based lighting devices and the trays. By adapting the vertical distance between the LED-based lighting devices and the trays, for example increasing the vertical distance between the LED-based lighting devices and the trays according to the height of plants growing in the trays, a room with a fixed height can have more growing layers and thus higher yields for the same surface area.

The recitation “vertical distance between LED-based lighting device and tray” as used herein refers to the shortest distance in the vertical direction (along the height of a rack) between a tray and the luminous surface of a LED-based lighting device, both positioned in the industrial plant growth facility.

In particular embodiments, the industrial plant growing facility may further comprise a light diffuser adapted for homogenising the light emanating from the LEDs-based lighting devices. Preferably, the light diffuser is configured for illuminating the whole plant disregarding its position in the rack. This may enhance the yield of the plants grown in the IPPC.

Preferably, the LED-based lighting devices are configured to be dimmable. This may increase the flexibly of the industrial plant growing facility to adapt to optimal growth conditions for different plant species and/or to optimal growth conditions for plants of the same species at different stages of plant growth.

In certain embodiments, the industrial plant growing facility as taught herein may further comprise a control unit configured for:
receiving information about the plant species of the plants in a tray, and controlling the transport system to move the tray to a predetermined position in the rack;
receiving information about the nutrient concentration measured in the growth medium; and controlling the fluidic system to adapt the nutrient concentration of the growth medium to a predetermined nutrient concentration;
receiving information about the pH measured in the growth medium; and controlling the fluidic system to adapt the pH of the growth medium to a predetermined pH;
receiving information about the temperature measured in the growth chamber; and controlling the climate system to adapt the temperature in the growth chamber to a predetermined temperature;
receiving information about the humidity measured in the growth chamber; and controlling a climate system to adapt the humidity in the growth chamber to a predetermined humidity;
controlling the LED-based lighting devices to provide a predetermined light spectrum and a predetermined light intensity;
receiving information about the carbon dioxide concentration measured in the growth chamber; and controlling the carbon dioxide system to adapt the carbon dioxide concentration in the growth chamber to a predetermined carbon dioxide concentration; and
optionally controlling the vertical inter-tray distance to a predetermined vertical inter-tray distance;
   wherein the predetermined nutrient concentration, the predetermined pH, the predetermined temperature, the predetermined humidity, the predetermined light spectrum, the predetermined light intensity, the predetermined carbon dioxide concentration, and optionally the predetermined vertical inter-tray distance, are determined by the plant species. In certain embodiments, the predetermined nutrient concentration, the predetermined pH, the predetermined temperature, the predetermined humidity, the predetermined light spectrum, the predetermined light intensity, the predetermined carbon dioxide concentration, and optionally the predetermined vertical inter-tray distance, may be further determined by the light interval, the growth stage, and/or the desired properties of the mature plants.

In particular embodiments, each rack may comprise at least 6 layers. Thus, in industrial plant growing facilities comprising racks comprising at least six layers, at least six times as many plants may be grown per unit area compared to industrial plant growth facilities in which only one layer is provided.

The term “layer” as used herein refers to a plurality of laterally displaced trays; in other words, a layer refers to a plurality of trays which are substantially at the same height in the industrial plant growing facility.

In certain embodiments, the LED-based lighting device may comprise at least 4 LEDs, the at least 4 LEDs comprising at least a UV LED, a blue LED, a green LED, and a red LED;
the UV LED being configured for emitting light having a wavelength of at least 100 nm to at most 400 nm;
the blue LED being configured for emitting light having a wavelength of at least 400 nm to at most 490 nm;
the green LED being configured for emitting light having a wavelength of at least 490 nm to at most 570 nm; and
the red LED being configured for emitting light having a wavelength of at least 570 nm to at most 700 nm, wherein the LED-based lighting device is configured for adapting the light intensity and/or light spectrum emitted by the UV LED, the blue LED, the green LED, and the red LED according to predetermined light intensity and/or light spectrum for the plant species.

Preferably, the LED-based lighting device comprises at least a UV LED, a blue LED, a green LED, and a red LED;
the UV LED being configured for emitting light having a wavelength of at least 300 nm to at most 350 nm;
the blue LED being configured for emitting light having a wavelength of at least 450 nm to at most 490 nm;
the green LED being configured for emitting light having a wavelength of at least 500 nm to at most 520 nm; and
the red LED being configured for emitting light having a wavelength of at least 600 nm to at most 650 nm.

In certain embodiments, the LED-based lighting device may further comprise a far-red LED, the far-red LED being configured for emitting a wavelength of at least 700 nm to at most 850 nm, preferably the far-red LED being configured for emitting a wavelength of at least 700 nm to at most 750 nm. In certain embodiments, the LED-based lighting device is configured for adapting the light intensity emitted by the far-red LED according to a predetermined light intensity. In certain embodiments, the LED-based lighting device is configured for adapting the light intensity and/or light spectrum emitted by the UV LED, the blue LED, the green LED, the red LED, and the far-red LED according to predetermined light intensity and/or light spectrum for the plant species. Far-red light excitations may support photochemical activity of the photosynthetic system of plants, as specified below.

The light intensity emitted by the various LEDs may be changed proportionally. By proportionally changing the light intensity emitted by the various LEDs, the light intensity emitted by the LED-based lighting device may be changed without changing the light spectrum emitted by the LED-based lighting device.

The light intensity emitted by the various LEDs may be changed independently. By independently changing the light intensity emitted by the various LEDs, the light spectrum emitted by the LED-based lighting device might be adapted.

The term “UV light” as used herein refers to light emitted by UV LEDs; the term “blue light” as used herein refers to light emitted by blue LEDs; the term “green light” as used herein refers to light emitted by green LEDs; the term “red light” as used herein refers to light emitted by red LEDs; and the term “far-red light” as used herein refers to light emitted by far-red LEDs.

Blue, green, and red light are sub-ranges of PAR. Irradiance of plants with PAR allows photosynthesis to occur. As pigments in foliage may differ between plant species, different plant species may have different sensitivities towards different components of the RAR spectrum. Therefore, spectral matching of light for specific plant species, thereby maximally exploiting spectral sensitivities, may allow obtaining optimum yields for minimal energy use. The LED-based lighting device provided herein allows for spectral optimization to specific plant species by modulating the current drawn by individual LEDs in the LED-based lighting devices.

Similarly, photosynthetic processes of different plants species may saturate at different light intensities. Matching the light intensity by which plants of a specific plant species are irradiated with the light intensity at which photosynthetic processes for that plant species saturate allows achieving maximal yield in an energy-efficient way.

Irradiance with UV light may be useful for increasing yield of certain plants, as specified below.

In particular embodiments, the industrial plant growing facility may be configured for providing at least two growth zones, wherein the at least two growth zones have at least a different temperature and/or a different carbon dioxide concentration. Preferably, the at least two growth zones are located in a vertical region of the growth chamber.

This may allow industrial plant growing facilities provided herein to concurrently grow plants belonging to more than one plant species in one industrial plant growing facility. This may enhance the versatility of the industrial plant growing facilities.

The recitation “vertical region of the growth chamber” as used herein refers to an uninterrupted region or area in a growth chamber or part thereof between a first height and a second height, the vertical distance between the first height and the second height being preferably 0.1 m to 2.0 m, more preferably 0.2 m to 1.5 m, for example 0.5 m to 1.0 m.

In certain embodiments, the industrial plant growing facility may be configured for providing concurrently at least two sets of growth conditions. In this case, vertical organisation of plant species is preferably based on required temperatures and CO₂ concentrations for optimal growth. In particular, plants requiring higher growth temperatures are preferably grown in higher layers compared to plants requiring lower growth temperatures; due to warmer air's tendency of rising above colder air, maintaining warmer air layers above colder air layers can be more readily accomplished than the reverse. Also, plants requiring higher CO₂ concentrations are preferably grown in lower layers compared to plants requiring lower CO₂ concentrations; due to CO₂'s higher density compared to atmospheric air, CO₂-poor air has a tendency of rising above CO₂-rich air such that maintaining CO₂-poor air layers on top of CO₂-rich air layers may be more readily accomplished than the reverse.

Preferably, the growth chamber is not physically comparted by means of dividers. On the contrary, growth conditions are preferably adapted such that using dividers is not necessary for achieving different growth conditions in different parts (growth zones) of the growth chamber.

In certain embodiments, the at least two growth zones may differ at least in one or more aspects chosen from the list comprising: the vertical inter-tray distance, nutrient concentration, temperature, humidity, light spectrum, light intensity, and carbon dioxide concentration; the at least two sets of growth conditions possibly being adapted to growing different plant species; and/or the at least two sets of growth conditions possibly adapted to growing the same plant species at different stages of plant growth.

A further aspect provides a LED-based lighting device for an industrial plant growing facility comprising a UV LED, a blue LED, a green LED, and a red LED;
the UV LED being configured for emitting light having a wavelength of at least 100 nm to at most 400 nm;
the blue LED being configured for emitting light having a wavelength of at least 400 nm to at most 490 nm;
the green LED being configured for emitting light having a wavelength of at least 490 nm to at most 570 nm; and
the red LED being configured for emitting light having a wavelength of at least 570 nm to at most 700 nm;
   wherein the LED-based lighting device is configured for adapting the light intensity and/or light spectrum emitted by the UV LED, the blue LED, the green LED, and the red LED according to a predetermined light intensity and/or light spectrum.

Preferably, the LED-based lighting device comprises a UV LED, a blue LED, a green LED, and a red LED; the UV LED being configured for emitting light having a wavelength of at least 300 nm to at most 350 nm; the blue LED being configured for emitting light having a wavelength of at least 450 nm to at most 490 nm; the green LED being configured for emitting light having a wavelength of at least 500 nm to at most 520 nm; and the red LED being configured for emitting light having a wavelength of at least 600 nm to at most 650 nm, wherein the LED-based lighting device is configured for adapting the light intensity and/or light spectrum emitted by the UV LED, the blue LED, the green LED, and the red LED according to a predetermined light intensity and/or light spectrum.

By proportionally changing the light intensity emitted by the various LEDs, the light intensity emitted by the LED-based lighting device may be changed without changing the light spectrum emitted by the LED-based lighting device. By independently changing the light intensity emitted by the various LEDs, the light spectrum emitted by the LED-based lighting device might be adapted.

Preferably, the LED-based lighting device is incorporated into an industrial plant growing facility as provided herein.

Blue, green, and red light are sub-ranges of photosynthetically active radiation (PAR). Irradiance of plants with PAR allows photosynthesis to occur.

Irradiance with UV light may be useful for increasing the yield of certain plants, for example for increasing the yield of Roman coriander. In addition, UV light may have the advantage of increasing and/or enhancing the content of secondary metabolites in plants. In addition, in some cases, the dry mass may be enhanced and/or increased when UV light is applied in combination with other light wavelengths.

In certain embodiments, the LED-based lighting device may further comprise a far-red LED, the far-red LED being configured for emitting a wavelength of at least 700 nm to at most 850 nm, wherein the LED-based lighting device is configured for adapting the light intensity emitted by the far-red LED according to a predetermined light intensity. Preferably, the far-red LED is configured for emitting light having a wavelength of at least 700 m to at most 750 nm.

Far-red light excitations may support photochemical activity of the photosynthetic system of plants. In particular embodiments, far-red light excitations may be used for growing flowering plants, in particular for regulating the time of flowering. In addition, far-red light excitations may be used for regulating the germination of seeds, elongation of seedlings, size, shape and number of leaves, chlorophyll synthesis, and/or straightening of epicotyl or hypocotyl of dicot seedlings. In particular embodiments, treatments with Far red light in leaf lettuces may increase fresh weight, dry weight, stem length, leaf length and/or leaf width. Furthermore, in particular embodiments, supplementation of PAR with light of far-red LEDs may have positive effects on the vegetative growth and/or color of lettuce.

A further aspect provides a method for growing plants of at least one plant species, comprising the steps of:
(a) providing an industrial plant growing facility as taught herein;
(b) placing a tray comprising seeds of the at least one plant species in the growth chamber;
(c) growing the seeds into mature plants, thereby obtaining mature plants; and,
(d) removing the tray comprising the mature plants out of the growth chamber, wherein during step (c) the nutrient concentration, the pH, the temperature, the humidity, the light spectrum, the light intensity, the carbon dioxide concentration, and optionally the vertical inter-tray distance, are adapted to a predetermined nutrient concentration, a predetermined pH, a predetermined temperature, a predetermined humidity, a predetermined light spectrum, a predetermined light intensity, a predetermined carbon dioxide concentration, and optionally a predetermined vertical inter-tray distance, determined by the plant species.

The term “nutrient concentration” as used herein refers to the concentration of nutrients in the aqueous growth medium.

In particular embodiments, when the plant is a leafy green, for example lollo bionda, spinach, or watercress; the predetermined day temperature may be about 20° C., the predetermined night temperature may be about 16° C., the predetermined day length may be about 18 h, the predetermined night length may be about 6 hours, the predetermined light intensity (PAR) may be about 300 μmol·m⁻²·s⁻¹, the predetermined humidity may be about 80%, the predetermined CO₂ concentration may be about 1200 ppm, the predetermined air flow may be at least 0.2 m/s to at most 0.5 m/s, the predetermined pH may be at least 5.5 to at most 7.5, and/or the aqueous growth medium may comprise nutrients at a predetermined nutrient concentration of at least 10 mg/l to at most 18 mg/l nitrogen, at least 6.0 mg/l to at most 15 mg/l phosphorous, at least 4.0 mg/l to at most 18 mg/l potassium, at least 23 mg/l to at most 84 mg/l calcium, at least 4.0 mg/l to at most 24 mg/l magnesium, and at least 0.9 mg/l to at most 1.0 mg/l iron. In certain embodiments, when the plant is a leafy green, during germination stage, the predetermined light spectrum may be far-red LED, blue LED, green LED, and red LED. In certain embodiments, when the plant is a leafy green, during seedling-to-harvest stage, the predetermined light spectrum may be UV LED, blue LED, green LED, red LED, and far-red LED.

In particular embodiments, when the plant is a leafy green, for example lollo bionda, spinach, or watercress, the aqueous growth medium may comprise at least 10 mg/l to at most 18 mg/l nitrogen, at least 6.0 mg/l to at most 15 mg/l phosphorous, at least 4.0 mg/l to at most 18 mg/l potassium, at least 23 mg/l to at most 84 mg/l calcium, at least 4.0 mg/l to at most 24 mg/l magnesium, and/or at least 0.9 mg/l to at most 1.0 mg/l iron. In particular embodiments, when the plant is a herb, for example basil, chive, or coriander; the predetermined day temperature may be at least 20° C. to at most 26° C., the predetermined night temperature may be at least 16° C. to at most 21° C., the predetermined day length may be about 18 hours, the predetermined light intensity (PAR) may be about 300 μmol·m⁻²·s⁻¹, the predetermined humidity may be about 80%, the CO₂ concentration may be about 1000 ppm, the predetermined air flow may be about 0.2 m/s, the predetermined pH may be at least 5.5 to at most 7.0, and/or the aqueous growth medium may comprise nutrients at a predetermined nutrient concentration of at least 15 mg/l to at most 25 mg/l nitrogen, at least 11 mg/l to at most 15 mg/l phosphorous, at least 11 mg/l to at most 15 mg/l potassium, at least 50 mg/l to at most 90 mg/l calcium, at least 24 mg/l to at most 42 mg/l magnesium, and at least 1.8 mg/l to at most 2.5 mg/l iron. In certain embodiments, when the plant is a herb, during germination stage, the predetermined light spectrum may be far-red LED, blue LED, green LED, and red LED. In certain embodiments, when the plant is a herb, during seedling-to-harvest stage, the predetermined light spectrum may be UV LED, blue LED, green LED, red LED, and far-red LED.

In particular embodiments, when the plant is a herb, for example basil, chive, or coriander, the aqueous growth medium may comprise at least 15 mg/l to at most 25 mg/l nitrogen, at least 11 mg/l to at most 15 mg/l phosphorous, at least 11 mg/l to at most 15 mg/l potassium, at least 50 mg/l to at most 90 mg/l calcium, at least 24 mg/l to at most 42 mg/l magnesium, and/or at least 1.8 mg/l to at most 2.5 mg/l iron.

In particular embodiments, when the plant is a halophyte, such as Salicornia, salsola, or sea aster, the day temperature may be at least 25° C. to at most 26° C., the predetermined night temperature may be at least 15° C. to at most 20° C., the predetermined day length may be about 18 hours, the predetermined night length may be about 6 hours, the predetermined light intensity (PAR) may be about 200 μmol·m⁻²·s⁻¹, the predetermined humidity may be at least 60% to at most 70%, the predetermined CO₂ concentration may be about 800 ppm, the predetermined air flow may be about 0.6 m/s, the predetermined pH may be at least 5.5 to at most 7.0, and/or the aqueous growth medium may comprise nutrients at a predetermined nutrient concentration of about 4.0 mg/l nitrogen, at least 5.0 mg/l to at most 6.0 mg/l phosphorous, at least 6.0 mg/l to at most 8.0 mg/l potassium, at least 40 mg/l to at most 50 mg/l calcium, at least 12 mg/l to at most 24 mg/l magnesium, at least 1.0 mg/l to at most 1.2 mg/l iron, and about 300 mg/l sodium. In certain embodiments, when the plant is a halophyte, during germination stage, the predetermined light spectrum may be far-red LED, blue LED, green LED, and red LED. In certain embodiments, when the plant is a halophyte, during seedling-to-harvest stage, the predetermined light spectrum may be far-red LED, blue LED, green LED, and red LED.

In particular embodiments, when the plant is a halophyte, such as Salicornia, salsola, or sea aster, the aqueous growth medium may comprise about 4.0 mg/l nitrogen, at least 5.0 mg/l to at most 6.0 mg/l phosphorous, at least 6.0 mg/l to at most 8.0 mg/l potassium, at least 40 mg/l to at most 50 mg/l calcium, at least 12 mg/l to at most 24 mg/l magnesium, at least 1.0 mg/l to at most 1.2 mg/l iron, and/or about 300 mg/l sodium.

In certain embodiments, prior to method of the present invention, the method comprises the step of determining a predetermined value for a parameter, such as a predetermined nutrient concentration, a predetermined pH, a predetermined temperature, a predetermined humidity, a predetermined light spectrum, a predetermined light intensity, a predetermined carbon dioxide concentration, and optionally a predetermined vertical inter-tray distance, for the plant species.

In certain embodiments, the method for establishing a predetermined value for a parameter for a plant species comprises:
(a′) providing an industrial plant growing facility as taught herein;
(b′) placing a tray comprising seeds of the at least one plant species in the growth chamber;
(c′) growing the seeds into mature plants under standard values for nutrient concentration, pH, temperature, humidity, light spectrum, light intensity, carbon dioxide concentration, and optionally vertical inter-tray distance, thereby obtaining mature plants;
(d′) removing the tray comprising the mature plants out of the growth chamber;
(e′) analysing one or more characteristics of the mature plants;
(f′) adapting one or more of the standard values for nutrient concentration, pH, temperature, humidity, light spectrum, light intensity, carbon dioxide concentration, and optionally vertical inter-tray distance;
(g′) placing a tray comprising seeds of the at least one plant species in the growth chamber;
(h′) growing the seeds into mature plants, thereby obtaining mature plants;
(j′) removing the tray comprising the mature plants out of the growth chamber;
(k′) analysing one or more characteristics of the mature plants;
(l′) comparing the results of the one or more characteristics of the mature plants obtained in step (e′) and step (k′); and
(m′) selecting the value resulting in more preferred characteristic(s) (e.g., in number and/or in quality of the characteristics) as a predetermined value for a parameter, such as a predetermined nutrient concentration, a predetermined pH, a predetermined temperature, a predetermined humidity, a predetermined light spectrum, a predetermined light intensity, a predetermined carbon dioxide concentration, and optionally a predetermined vertical inter-tray distance, for the plant species.

In certain embodiments, the standard values are values as are known in the art for growing the plant species.

In particular embodiments, air flow in the growth chamber is adapted during step (c) to a predetermined air flow determined by the plant species being grown in the growth chamber. The predetermined air flow may preferably be between at least 0.20 m/s to at most 2.0 m/s, for example 0.40 m/s.

This method may allow growing plants in a resource-efficient and cost effective way.

In particular embodiments of the methods as taught herein, step (d) is executed by the transport system. In particular embodiments, step (d) may be followed by the step of collecting the tray comprising mature plants from the transport system. In particular embodiments of the methods as taught herein, step (d) is executed by the transport system, and step (d) is followed by the step: collecting the tray comprising mature plants from the transport system.

In certain embodiments, the predetermined nutrient concentration, the predetermined pH, the predetermined temperature, the predetermined humidity, the predetermined light spectrum, the predetermined light intensity, the predetermined carbon dioxide concentration, and optionally the predetermined vertical inter-tray distance, may be further determined by the light interval, the growth stage, and/or the desired properties of the mature plants.

The term “light interval” refers to the day interval of a day-night cycle or the night interval of a day-night cycle. The term “day-night cycle” as used herein refers to the application of growth conditions in alternating day intervals and night intervals.

In certain embodiments, the industrial plant growing facility is configured for applying growth conditions in day-night cycles, and wherein a first set of growth conditions is adapted to day-parts of the day-night cycles, and the second set of growth conditions is adapted to night-parts of the day-night cycles.

In particular embodiments, the day-night cycle may vary during plant growth for mimicking seasonal changes during plant growth.

In particular embodiments, the day-night cycle may involve the application of blue, green, and red light during the day-part of the cycle; and the application of red and/or blue light during the night-part of the day-night cycle.

In particular embodiments, the red and blue light are alternatingly applied during subsequent nights in the day-night cycle; that is one night red light is applied, the next night blue light is applied, the night after that red light is applied, and so on.

The use of alternating LED light irradiation during plant growth may advantageously induce/enhance active compounds and/or secondary metabolites in a faster way than in normal LED conditions lights without hampering the morphology of the plant. Moreover, alternating LED light irradiation may also have a positive impact on plant growth. In particular embodiments, the day-night cycles involve the application of a day-temperature during the day-part of the cycle and a night-temperature during the night-part of the cycle, the day-temperature being higher than the night-temperature.

Generally, the day-temperature and the night-temperature are adapted to growing specific crops, as illustrated in the examples.

In particular embodiments, the day-night cycles involve the application of a day CO₂ level during the day-part of the cycle and the application of a night CO₂ level during the night part of the cycle, the day CO₂ level being higher than the night CO₂ level, as illustrated in the examples. Preferably, the night CO₂ level is about equal to the atmospheric CO₂ concentration. As CO₂ is used for enhancing photosynthetic processes, providing elevated CO₂ concentrations at night may be of little or no use. Providing lower, preferably atmospheric, CO₂ concentrations at night may be an effective way of minimizing CO₂-related expenditures.

In particular embodiments, the day-parts of the day-night cycles lasts at least 12 to at most 22 hours, preferably at least 15 to at most 20 hours, more preferably about 18 hours. In particular embodiments, the night-part of the day-night cycles last at least 2 to at most 12 hours, preferably at least 4 to at most 9 hours, more preferably about 6 hours.

In certain embodiments of the industrial plants growing facilities, methods, or uses, as taught herein:
the plant species may be a plant species belonging to the group of leafy greens, herbs, halophytes, or medicinal plants;
the light interval of the plant species may be the day interval of the day-night cycle or the night interval of the day-night cycle;
the growth stage may be the germination stage or the seedling-to-harvest stage, preferably wherein the germination stage lasts at least two days to at most three weeks, preferably wherein the seedling-to-harvest stage lasts at least 11 days to at most 713 days, preferably at least 20 days to at most 100 days, for example 50 days; and/or
the desired properties of the mature plants may comprise the taste of the mature plants, the colour of the mature plants, and the shape of the mature plants.

In particular, treatments with LED-based lighting devices (such as LED-based lighting devices comprising light emitting diodes (LEDs) chosen from the list comprising Red LEDs, far red LEDs, and blue LEDs) may enhance the plant secondary metabolism or may enhance the concentration of small molecules which in effect can enhance certain sensorial qualities on plants like taste, smell, crunchiness, color, appearance. In example, growing rucola under a maximum temperature of 20° C. and a minimum temperature of 16° C., with a day-night cycle of 18h day and 6h night, under a PAR of 300 μmol during daytime with treatments of UV light during day and/or night, preferably during the night, under a humidity of 80%, with a supply of CO₂ at 1200 ppm, under an nutrient water irrigation solution of NPK (Nitrogen-Phosphorous-Potassium) (10-5-26), for around 30 days of cultivation results in rucola having a peppery taste and being rich in vitamin A, vitamin C, and calcium.

Suitable non-limiting examples of vegetables, including all kinds of leafy greens, including green lettuce, red lettuce, romaine lettuce, iceberg lettuce, chop soy greens, endive, golden purslane, mina, komatsuna, pak choi, spinach, swiss chard, ruby chard, red mustard, watercress, redskin dwarf sweet pepper, radicchio, baby peppers, bok choy, Chinese broccoli, Chinese celery, curry leaves, lemon grass, pea shoots, sesame leaves, choy sum, tatsoi, frilly mustard, baby spinach, bloomsdale spinach, dakon sprout, salad savoy, frisee, green oakleaf, baby leek, garlic chives, marjoram, purslane sorrel, tarragon, broccoleaf, collard greens, dandelion greens, honey gem lettuce, kohlrabi, mesclun, miner's lettuce, mustard greens, arrowhead spinach, puntarelle, epazote, red watercress, Russian kale, scarlet butter lettuce, tat soi, upland cress, watercress living, broccolini, kale, read oak leaf, red salanova, sprouting broccoli, Chinese broccoli, broccoli rabe, green broccoli, Chinese spinach, mibuna, minutina, sweet pepper, ramsons, sprouting onion seeds, ‘little gem’ lettuce, ‘marvel of four seasons’ lettuce, ‘green frills’ mustard, gai choy mustard, land seaweed, Greek cress, summer savory, oriental radish (daikon), Chinese lettuce (Celtuce), fenugreek, Chinese cabbage (yow choy), napa cabbage, rainbow Swiss chard, specialty hot peppers, and Easter white eggplant.

Suitable non-limiting examples of herbs include rocket (rucola), sorrel, coriander, basil (common), basil (Thai), basil (lemon), Cayenne pepper, garlic chives, wild thyme, thyme (lemon), oregano, rosemary, thyme, chives, sage, cilantro, leaf radish, marjoram, lemon balm, Mache, chervil, dill, marjoram, sorrel, tarragon, ice plant, rhubarb, parsley, collard, celery, fennel, mache, tango, chervil, Italian parsley, rapini, Chinese parsley, green purslane, arugala ‘Giove’, basil (purple ruffles), lemon balm, lemon basil, and purple basil.

Suitable non-limiting examples of medicinal plants include peppermint, lavender, anisi fructus, echinaceae purpureae, ephedra, holy basil, sage, stevia, valeriana officinalis, ginseng, Peruvian ginseng (Maca), daffodil, crambe, camellia, Russian dandelion, St. John's wort, blue cohosh, roman coriander, holy ghost, masterwort, female ginseng, stinging nettle, yerba mansa, bloodroot, and drumstick tree.

Suitable non-limiting examples of halophytes include samphire (glasswort), sea aster (spinach), salsola soda, sea beet, rock samphire, sea kale, New Zealand spinach, saltbush, and alexanders (smyrnium olusatrum).

In certain embodiments, step (c) may be performed in at least two growth zones, wherein the at least two growth zones have at least a different temperature and a different carbon dioxide concentration. Preferably, the at least two growth zones are located in a vertical region of the growth chamber. In certain embodiments,
the at least two growth zones are adapted to growing plants of different plant species; and/or
the at least two growth zones are adapted to growing plants at different stages of plant growth.

In particular embodiments, the at least two growth zones are adapted to growing plants of the same or different plant species at different stages of plant growth.

The term “growth zone” as used herein refers to a part of a growth chamber having substantially uniform growth conditions. The term “substantially growth conditions” as used herein refers to a set of growth conditions which are suitable for growing a set of plants of a certain plant species. For example, the growth conditions in a growth zone may deviate no more than about 10%, for example no more than 5%, for example no more than 1%, for example no more than 0.1% from their set or predetermined values.

In certain embodiments, the day-parts of the day-night cycles last at least 12 to at most 22 hours, preferably at least 15 to at most 20 hours, more preferably about 18 hours; and wherein the night-parts of the day-night cycles last at least 2 to at most 12 hours, preferably at least 4 to at most 9 hours, more preferably about 6 hours, wherein
optionally, the day-night cycles involve the application of blue, green and red light during the day-parts of the cycles; and the application of red and/or blue light during the night-parts of the cycles;
optionally, the day-night cycles involve the application of a day-temperature during the day-parts of the cycles and a night-temperature during the night-parts of the cycles, the day-temperature being higher than the night-temperature; and/or
optionally, the day-night cycles involve the application of a day CO₂ level during the day-parts of the cycles and the application of a night CO₂ level during the night part of the cycles, the day CO₂ level being higher than the night CO₂ level.

The use of alternating LED light irradiation during plant growth may allow inducing the presence of and/or enhancing the concentration of active compounds and/or secondary metabolites in faster compared to when non-alternating LED irradiation is applied. This may be advantageously done without hampering the morphology of the plant. Moreover, alternating LED lights irradiation may also have a positive impact on plant growth.

Day temperatures reported herein are the maximum temperatures which plants need for optimum growth. Night temperatures reported herein are expressed as the minimum temperature which plants need for optimal growth. During night periods, lights are turned off, or the amount of light irradiated on the plants during night periods does not generate significant heat. The recitation “does not generate significant heat” as used herein refers to heat generation lower than 40 W/m², preferably lower than 20 W/m², more preferably lower than 10 W/m², wherein the heat fluxes are expressed per m².

In certain embodiments, the methods as taught herein may comprise the steps:
(e) repeating step (b) multiple times, wherein at least two trays comprise plants of at least two different plants species;
(f) executing step (c) for the at least two trays provided in step (e); and,
(g) repeating step (d) multiple times, wherein the at least two trays provided in step (e) are removed out of the growth chamber.

In certain embodiments, the methods as taught herein may comprise the steps:
(h) repeating step (b) a number (n) of times, wherein the trays comprise plants of one plant species, the average time between two consecutive repetitions of step (b) being one n^{th} of the days to harvest the one plant species;
(j) executing step (c) for the trays provided in step (h), wherein the predetermined nutrient concentration, the predetermined pH, the predetermined temperature, the predetermined humidity, the predetermined light spectrum, the predetermined light intensity, the predetermined carbon dioxide concentration, and optionally the predetermined vertical inter-tray distance, are determined by the growth stage of the plants;
(k) repeating step (d) n times, wherein the trays provided in step (h) are removed out of the growth chamber.

In particular embodiments, n may be more than 2 (n>2). In particular embodiments, n may be more than 3 (n>3). In particular embodiments, n may be more than 4 (n>4). In particular embodiments, may be more than 5 (n>5), such as n may be more than 6 (n>6), more than 7 (n>7), more than 8 (n>8), more than 9 (n>9). In particular embodiments, n may be more than 10 (n>10), such as n may be more than 12 (n>12), more than 24 (>24), more than 36 (n>36), or more than 48 (n>48). Hence, the industrial plant growing facility may be advantageously used for continuous plant production. Preferably, only the average time between two consecutive repetitions of step b are one n^{th} of the days to harvest of that plant species. The delay between individual repetitions of step b may be adapted according to projected demand.

Also provided herein is the use of an industrial plant growing facility provided herein for growing leafy greens, herbs, halophytes, and/or medicinal plants.

Also provided herein is the use of a LED-based lighting device provided herein for growing leafy greens, herbs, halophytes, and/or medicinal plants.

Further provided is a computer program product comprising one or more computer readable media having computer executable instructions for controlling the industrial plant growing facility as taught herein.

The above aspects and embodiments are further supported by the following non-limiting examples.

### Examples

### Example 1: Industrial Plant Growth Facility According to an Embodiment of the Present Invention

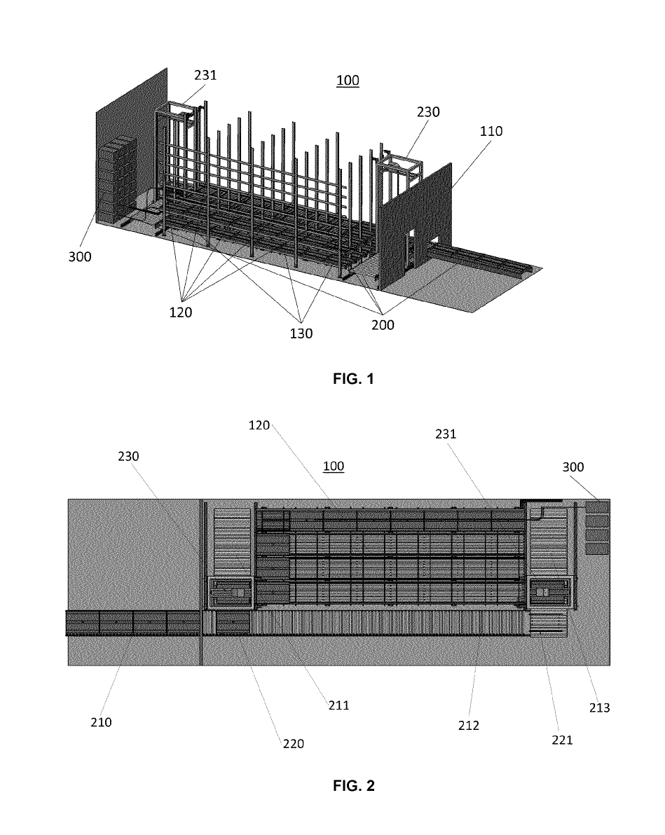

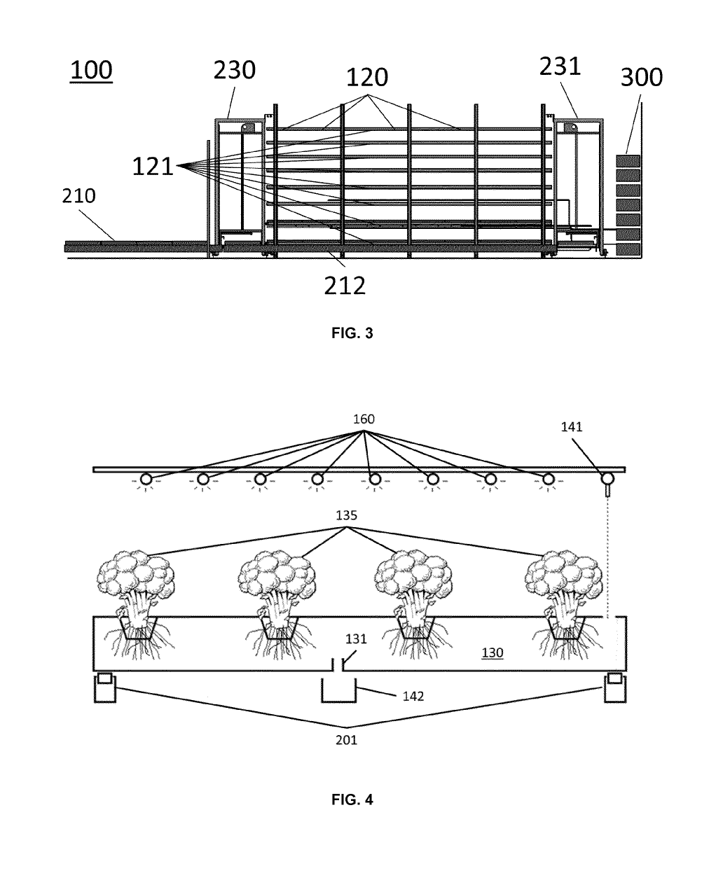

In a first example, reference is made to FIGS. 1 to 3. FIGS. 1 to 3 show different views of an industrial plant growing facility (100). The industrial plant growing facility (100) comprises a housing (110), racks (120), trays (130), and an automated transport system (200). The housing (110) encloses a growth chamber for growing plants. The racks are positioned in the growth chamber. Each rack comprises 8 layers (121). The two lower layers have an inter-tray distance of 80 cm. The two middle layers have an inter-tray distance of 60 cm. The four upper layers have an inter-tray distance of 40 cm. The trays (130) are positioned in the racks. The automated transport system (200) comprises four roller conveyers (210, 211, 212, 213), two chain transfer devices (220, 221), and two elevators (230, 231). The automated transport system (200) is configured for placing the trays (130) in the industrial plant growing facility (100).

The industrial plant growing facility may further comprise a programmable logic controller (PLC) for regulating nutrient concentration, pH, conductivity (EC), temperature, humidity, light spectrum, light intensity, carbon dioxide concentration, pumps, optionally the vertical inter-tray distance, and internal transport in the industrial plant growing facility.

The PLC is configured for controlling several logistic functions of the industrial plant growing facility including
actuating the lifts, the lifts being configured for positioning and/or extracting trays from racks;
controlling the residence time of trays comprising specific plants in the racks, based on predetermined values of the residence time.

Furthermore, the PLC is operationally coupled to a heat pump for controlling the temperature of the industrial plant growth facility. The PLC is configured for arranging a day-temperature and a night-temperature. Also, the PLC is operationally coupled to several temperature sensors for continual temperature monitoring.

Additionally, the PLC is configured for continually providing nutrients to the trays comprising plants. The amount of nutrients provided to the plants in a specific tray depends on the specific plant species being grown in that tray.

The PLC is configured for monitoring and controlling the nutrient concentration such that the electrical conductivity of the nutrient solution is between 0.5 to 4.0 mS/cm, in the case of fresh water nutrient solution. In the case of sea water or water with high concentration of salts, the electrical conductivity of the nutrient solution is between up to 40 mS/cm. In addition, the PLC is configured for monitoring and controlling the pH between 5.5 and 8.5.

The PLC is operationally coupled to an air moisturizer and optionally to a dehumidifier, and is configured for monitoring and controlling relative humidity between at least 50% to at most 80%.

### Example 2: Industrial Plant Growth Facility According to an Embodiment of the Present Invention

In a further example, reference is made to FIG. 4. FIG. 4 represent an enlarged part of an industrial plant growing facility according to an embodiment of the present invention. FIG. 4 shows a tray (130) comprising plants (135). The trays are supported by a conveyor (201), the conveyor being configured for laterally displacing the trays. The plants are lit by means of a LED-based lighting device (160), and the trays are provided with nutrients by means of a nozzle (141), the nozzle being part of a fluidic system for providing water and nutrients. The tray (130) further comprises an overflow (131) configured for allowing excess water comprising nutrients to be transferred to a drain (142) by means of gravitational pull.

### Example 3: Method for Growing Plants According to an Embodiment of the Present Invention

A further example relates to a specific method for growing plants according to an embodiment of the present invention. The method is performed using an industrial plant growing facility (100) according to an embodiment of the invention, as schematically shown in FIGS. 1 to 3. A tray comprising seeds of Lollo bionda (Green lettuce, Lactuca sativa var. crispa) is brought into the industrial plant growth facility (100) by means of a conveyor (210). The conveyor (210) brings the tray to a chain transfer device (220). The chain transfer device (220) tranfers the tray to an elevator (230). The elevator (230) lifts the tray, for example for about 75 cm, and laterally displaces the tray into one of the racks (120). As shown in FIG. 4, LED-based lighting devices (160) are positioned above the tray (130) and illuminate the seeds in the tray. The tray (130) is provided with nutrients and water by means of a fluidic system comprising a nozzle (141) which is operationally coupled with water- and nutrient reservoirs (300). The seeds gradually grow into plants (135). During plant growth, the nutrient concentration, the pH, the temperature, the humidity, the light spectrum, the light intensity, the carbon dioxide concentration, and air flow are adapted to a predetermined nutrient concentration, a predetermined pH, a predetermined temperature, a predetermined humidity, a predetermined light spectrum, a predetermined light intensity, a predetermined carbon dioxide concentration, and a predetermined airflow for Lollo bionda as provided in Table 1. Table 1 provides a predetermined nutrient concentration, a predetermined pH, a predetermined temperature, a predetermined humidity, a predetermined light spectrum, a predetermined light intensity, a predetermined carbon dioxide concentration, and a predetermined air flow, for several plant species during the germination stage (seed-to-seedling stage). The day interval is 18 hours and the night interval is 6 h for all plant species.

TABLE 1
Predetermined values for nutrient concentration, pH, temperature, humidity, light
spectrum, light intensity, carbon dioxide concentration, and air flow for several plant species during
the germination stage

| | Category | | | | | | | | |
|---|---|---|---|---|---|---|---|---|---|
| | Leafy greens | | | Herbs | | | Halophytes | | |
| | Crop | | | | | | | | |
| | Lollo | | | | | | | Salsola | |
| | bionda | Spinach | Watercress | Basil | Chive | Coriander | Glasswort | soda | Sea Aster |
| Day temp (° C.) | 20 | 20 | 20 | 26 | 20 | 25 | 25 | 26 | 25 |
| Night temp | 16 | 16 | 16 | 21 | 16 | 21 | 15 | 20 | 15 |
| (° C.) | | | | | | | | | |
| Light intensity | 200 | 200 | 200 | 200 | 200 | 200 | 150 | 150 | 150 |
| (μmol/m²/s) | | | | | | | | | |
| Light | B/G/R/FR | B/G/R/FR | B/G/R/FR | B/G/R/FR | B/G/R/FR | B/G/R/FR | B/G/R/FR | B/G/R/FR | B/G/R/FR |
| spectrum | | | | | | | | | |
| Humidity (%) | 80 | 80 | 80 | 80 | 80 | 80 | 60 | 65 | 70 |
| CO₂ (ppm) | 350 | 350 | 350 | 350 | 350 | 350 | 350 | 350 | 350 |
| Ventilation | 0.2-0.5 | 0.2-0.5 | 0.2-0.5 | 0.2-0.5 | 0.2-0.5 | 0.2-0.5 | 0.5-1.0 | 0.5-1.0 | 0.5-1.0 |
| (m/s) | | | | | | | | | |
| pH | 5.5-6.0 | 6.0-6.5 | 6.0-7.5 | 5.5-6.5 | 6.0-6.5 | 6.5-7.0 | 5.5-7.0 | 5.5-7.0 | 5.5-7.0 |
| Nutrients | | | | | | | | | |
| N (mg/l) | 10 | 15 | 18 | 15 | 15 | 25 | 4 | 4 | 4 |
| P (mg/l) | 8 | 15 | 6 | 15 | 11 | 12 | 6 | 5 | 6 |
| K (mg/l) | 4 | 15 | 18 | 15 | 11 | 12 | 8 | 6 | 8 |
| Ca (mg/l) | 50 | 84 | 23 | 60 | 50 | 90 | 40 | 40 | 50 |
| Mg (mg/l) | 20 | 24 | 4 | 24 | 30 | 42 | 12 | 12 | 24 |
| Fe (mg/l) | 1 | 0.9 | 1 | 2.2 | 1.8 | 2.5 | 1.2 | 1.2 | 1 |
| Na (mg/l) | — | — | — | — | — | — | 100 | 100 | 100 |
| Days to | 14 | 20 | 7 | 20 | 20 | 20 | 20 | 20 | 20 |
| seedling | | | | | | | | | |

B: blue,
G: green,
R: red,
FR: far red,
UV: ultra-violet

Table 2 provides a predetermined nutrient concentration, a predetermined pH, a predetermined temperature, a predetermined humidity, a predetermined light spectrum, a predetermined light intensity, a predetermined carbon dioxide concentration, and a predetermined air flow, for several plant species during the seedling-to-harvest stage. The day interval is 18 hours and the night interval is 6 h for all plant species.

TABLE 2
Predetermined values for nutrient concentration, pH, temperature, humidity, light
spectrum, light intensity, carbon dioxide concentration, and air flow for several plant species during
the seedling-to-harvest stage

| | Category | | | | | | | | |
|---|---|---|---|---|---|---|---|---|---|
| | Leafy greens | | | Herbs | | | Halophytes | | |
| | Crop | | | | | | | | |
| | Lollo | | | | | | | Salsola | |
| | bionda | Spinach | Watercress | Basil | Chive | Coriander | Glasswort | soda | Sea Aster |
| Day temp (° C.) | 20 | 20 | 20 | 26 | 20 | 25 | 25 | 26 | 25 |
| Night temp (° C.) | 16 | 16 | 16 | 21 | 16 | 21 | 15 | 20 | 15 |
| Light intensity | 300 | 300 | 300 | 300 | 300 | 300 | 200 | 200 | 200 |
| (μmol/m²/s) | | | | | | | | | |
| Light spectrum | B/G/R/FR | B/G/R/ | B/G/R/ | B/G/R/FR | B/G/R/FR | B/G/R/FR | B/G/R/FR | B/G/R/FR | B/G/R/FR |
| | & UV | FR & UV | FR & UV | & UV | & UV | & UV | | | |
| Humidity (%) | 80 | 80 | 80 | 80 | 80 | 80 | 60 | 65 | 70 |
| CO₂ (ppm) | 1200 | 1200 | 1200 | 1000 | 1000 | 1000 | 800 | 800 | 800 |
| Ventilation (m/s) | 0.2-0.5 | 0.2-0.5 | 0.2-0.5 | 0.2-0.5 | 0.2-0.5 | 0.2-0.5 | 0.5-1.0 | 0.5-1.0 | 0.5-1.0 |
| pH | 5.5-6.0 | 6.0-6.5 | 6.0-7.5 | 5.5-6.5 | 6.0-6.5 | 6.5-7.0 | 5.5-7.0 | 5.5-7.0 | 5.5-7.0 |
| Nutrients | | | | | | | | | |
| N (mg/l) | 10 | 15 | 18 | 15 | 15 | 25 | 4 | 4 | 4 |
| P (mg/l) | 8 | 15 | 6 | 15 | 11 | 12 | 6 | 5 | 6 |
| K (mg/l) | 4 | 15 | 18 | 15 | 11 | 12 | 8 | 6 | 8 |
| Ca (mg/l) | 50 | 84 | 23 | 60 | 50 | 90 | 40 | 40 | 50 |
| Mg (mg/l) | 20 | 24 | 4 | 24 | 30 | 42 | 12 | 12 | 24 |
| Fe (mg/l) | 1 | 0.9 | 1 | 2.2 | 1.8 | 2.5 | 1.2 | 1.2 | 1 |
| Na (mg/l) | — | — | — | — | — | — | 300 | 300 | 300 |
| Days to harvest | 25 | 40 | 20 | 40 | 60 | 40 | 60 | 60 | 60 |

B: blue,
G: green,
R: red,
FR: far red,
UV: ultra-violet

The common names provided in Tables 1 and 2 are further clarified with their associated Latin denomination: Lollo bionda (Lactuca sativa var. crispa), Spinach (Spinacia oleracea), watercress (Nasturtium officinale), Basil (Ocimum basilicum), Chives (Allium schoenoprasum), Coriander (Coriandrum sativum), Glasswort (Salicornia europaea), Salsola soda (Salsola komarovii) and Sea aster (Aster tripolium).

After 25 days, when the plants of Lollo bionda have reached maturity, the tray is transported by means of a conveyor to a lift (231). The lift (231) lowers the tray, for example for about 75 cm. A chain transfer device (221) brings the tray to a conveyor (212). The conveyor (212) brings the tray to the conveyor (210) by which the tray entered the industrial plant growing facility (100). Finally, the conveyor (210) transports the tray out of the industrial plant growth facility. The mature plants in the tray are ready for shipment. The method can be immediately repeated for growing plants of other plant species, such as for example spinach (Spinacia oleracea), watercress (Nasturtium officinale), basil Ocimum basilicum), chive (Allium schoenoprasum), coriander (Coriandrum sativum), glasswort (Salicornia europaea), Salsola soda (Salsola komarovii) and Sea aster (Aster tripolium), with limited or even no manual changes to the industrial plant growing facility. Hence, the method illustrating the present invention advantageously allows serially growing plants of different plant species with satisfying flexibility.

### Example 4: Method for Growing Plants of at Least Two Different Plant Species According to an Embodiment of the Present Invention

In a further example, reference is made to a specific method and set-up for concurrently growing two different plants in one industrial plant growing facility. The industrial plant growing facility comprises a plurality of racks in which a plurality of trays are positioned in 12 layers. The trays in the four lower layers (i.e., lower part) comprise lollo bionda plants, the trays in the middle four layers (i.e., middle part) comprise chive plants, and the trays in the upper four layers (i.e., upper part) comprise salsola.

In the lower part of the industrial plant growing facility, the predetermined temperature during day and during night is set at 20° C. and at 16° C., respectively. The CO₂ concentration in the lower part of the industrial plant growing facility is set at 1200 ppm. These growth conditions in the lower part of the industrial plant growing facility are optimal for Lollo bionda plants.

In the growth chamber, the temperature gradually increases towards the upper part and the CO₂ concentration gradually decreases towards the upper part.

In particular, the day and night temperatures at the four middle trays is about 22° C. and about 18° C., respectively. The CO₂ concentration at the four middle trays is about 1000 ppm. The temperature is near-optimal for growing chive. The carbon dioxide concentration is optimal for chive.

Furthermore, the day- and night temperature at the four upper trays is about 26° C. and about 20° C., respectively. The CO₂ concentration at the four upper trays is about 800 ppm. This temperature and carbon dioxide concentration is optimal for salsola.

The industrial plant growing facility illustrating the invention allows the creation of three different growth zones, each growth zone having a temperature and carbon dioxide concentration which is optimal or near-optimal for the plant species which is grown in the growth zone.

The temperature and CO₂ concentration distribution is relatively stable since the warmer air comprising less CO₂ rises above the colder air comprising more C02.

Table 3 provides the position for specific plant species in the racks of an industrial plant growing facility according to an embodiment of the present invention. Due to their position in the racks, the plants of a plant species can grow in a growth zone having a temperature and carbon dioxide concentration, which is optimal or near-optimal for the plant species. This advantageously allows simultaneously growing plants of different plant species.

TABLE 3
position for specific plant species in the racks of an industrial plant growing facility
according to an embodiment of the present invention

| | Category | | | | | | | | |
|---|---|---|---|---|---|---|---|---|---|
| | Leafy greens | | | Herbs | | | Halophytes | | |
| | Crop | | | | | | | | |
| | Lollo bionda | Spinach | Watercress | Basil | Chive | Coriander | Salicornia | Salsola | Sea Aster |
| Position in rack | lower | lower | lower | mid-upper | mid-low | mid-upper | upper | upper | upper |

Hence, the industrial plant growing facility and the method illustrating the present invention advantageously allow simultaneously growing plants of different plant species with limited or even no manual changes to the industrial plant growing facility and without the use of dividers separating the growth zones.

### Example 5: Method for Growing Plants in an Industrial Plant Growing Facility Provided Herein

A further example relates to a specific method for growing plants in the industrial plant growing facility (100) schematically shown in FIGS. 1 to 3. A tray is brought into the industrial plant growth facility (100) by means of a conveyor (210). The conveyor (210) brings the tray to a chain transfer device (220). The chain transfer device (220) tranfers the tray to an elevator (230). The elevator (230) lifts the tray for about 75 cm and laterally displaces the tray into one of the racks (120). As shown in FIG. 4, LED-based lighting devices (160) are positioned above the tray (130) and illuminate the seeds in the tray. The tray (130) is provided with nutrients and water by means of a fluidic system comprising a nozzle (141) which is operationally coupled with water- and nutrient reservoirs (300). The seeds gradually grow into plants (135). When the plants (135) have reached maturity, the tray is transported by means of a conveyor to a lift (231). The lift (231) lowers the tray for about 75 cm. A chain transfer device (221) brings the tray to a conveyor (212). The conveyor (212) brings the tray to the conveyor (210) by which the tray entered the industrial plant growing facility (100). Finally, the conveyor (210) transports the tray out of the industrial plant growth facility. The mature plants in the tray are ready for shipment.

### Example 6: Programmable Logic Controller

A further example relates to a programmable logic controller (PLC) for regulating climate conditions and internal transport in the industrial plant growing facility.

The PLC is configured for controlling several logistic functions of the industrial plant growing facility:
actuating the lifts, the lifts being configured for positioning and/or extracting trays from racks;
controlling the residence time of trays comprising specific plants in the racks, based on predetermined values of the residence time.

Furthermore, the PLC is operationally coupled to a heat pump for controlling the temperature of the industrial plant growth facility. The PLC is configured for arranging a day-temperature and a night-temperature. Also, the PLC is operationally coupled to several temperature sensors for continual temperature monitoring.

Additionally, the PLC is configured for continually providing nutrients to the trays comprising plants. The amount of nutrients provided to the plants in a specific tray depends on the specific plant species being grown in that tray.

The PLC is configured for monitoring and controlling the nutrient concentration such that the electrical conductivity of the nutrient solution is between 0.5 to 2.0 mS/cm. In addition, the PLC is configured for monitoring and controlling the pH between 5.5 and 8.5.

The PLC is operationally coupled to an air moisturizer and to a dehumidifier and is configured for monitoring and controlling relative humidity between at least 50% to at most 80%.

Furthermore, the PLC is operationally coupled to the plurality of LED-based lighting devices for controlling light spectrum and light intensity based on predetermined values. In addition, the PLC is configured for turning on- and off the LED-based lighting devices based on day-night cycles, day-parts lasting between 16 hours and 18 hours, and night-parts lasting between 6 hours and 8 hours.

Furthermore, the PLC controller is operationally coupled to a CO₂ controller, the PLC controller being configured for controlling the CO₂ concentration between at least 500 ppm and at most 1200 ppm.

Furthermore, the PLC controller is operationally coupled to a ventilator. The PLC controller is configured for controlling air speed around 0.2 m/s up to 1 m/s.

### Example 7: Determining Predetermined Germination Light Spectra

In the present example, reference is made to a specific method for determining predetermined lighting conditions (i.e., light spectra and light intensities) during germination of Roman coriander seeds.

First, predetermined growth conditions during germination are determined by testing different lighting conditions:

a. illuminating sown seeds during a timeframe of one hour;
b. illuminating sown seeds during a timeframe of three hours;
c. illuminating sown seeds during a timeframe of six hours; and
d. illuminating sown seeds during a day-night cycle.

The LED-based lighting devices used for illuminating the seeds comprise four types of LEDs: blue LEDs emitting light having a wavelength of 450 nm to 490 nm, green LEDs emitting light having a wavelength of 500 nm to 520 nm, red LEDs emitting light having a wavelength of 600 nm to 650 nm, and UV LEDs emitting light having a wavelength of 300 nm to 350 nm.

The seeds are embedded overnight at 4° C. in aqueous growth medium and/or water.

Subsequently, the seeds are sown and the tests for the lighting conditions are performed.

A minimum of ten seeds are used with three biological repeats for ensuring representativeness of the experiments.

In particular, the following growth conditions are used: temperature between 15° C. and 20° C., humidity of 75%, PAR of 300 μmol·m⁻²·s⁻¹, 105 ppm nitrogen (N), 15 ppm phosphor (P), 115 ppm potassium (K), pH=5.7, and CO₂ concentration of 800 to 1000 ppm.

In a next stage the impact of different light spectra and treatments on germination is evaluated by comparing different plants at the end of the germination stage with a control group. In the control group, different plants are treated with standard light treatment in which fluorescent grow lights are used. In particular, the following characteristics are evaluated:
determination of germination efficiency by counting the fraction of germinated seeds;
measuring germination time; and,
determination of the growth of seedlings by visual counting of the number of leaves, photo image analysis of leaf area, and photo image analysis of hypocotyl length,

Three iterations are used in which the wavelength of the light used in the light treatments is varied within a limited range. In particular, the wavelength of light emitted by the blue LED is varied between at least 450 nm and at most 480 nm, the wavelength of the green LED is kept constant at about 510 nm, the wavelength of the red LED is varied between at least 630 nm and at most 660 nm, and the wavelength of the UV LED is kept constant at 320 nm.

The predetermined light intensity and light spectrum emitted by the LED-based lighting devices are selected to correspond to the most effective light treatment for germination. In particular, cost is taken into account as a function of the harvest time and the quality of the plants (e.g. as determined by the concentration of pharmacologically active compounds in medicinal plants).

### Example 8: Determining Predetermined Parameters in the Seedling-to-Harvest Growth Stage

The present example relates to an exemplary method for determining predetermined light spectra and light intensities during the seedling-to-harvest growth stage.

Starting with trays comprising seedlings, the seedlings are exposed to a day/night regime. Three different generic cycles are applied:
a. 18 h/6 h (day/night): blue/red/green day phase, darkness during the night phase;
b. 18 h/6 h (day/night): blue/red/green day phase, low-intensity blue/red night phase;
c. 18 h/6 h (day/night): blue/red/green day phase, low-intensity alternating only blue and only red night phases (i.e., one night only blue light, the next only red light, then only blue light, etc.)

A minimum of ten plants per selected plant species are used with three biological repeats for representativeness of the experiments. In particular, the following growth conditions are used: temperature between 15° C. and 20° C., humidity of 75%, CO₂ concentration of 800 to 1000 ppm, PAR of 300 μmol·m⁻²·s⁻¹, 105 ppm N, 15 ppm P, 115 ppm K, and pH=5.7.

The impact of different light spectra and light intensities during crop growth is evaluated by comparing crops at the end of the seedling-to-harvest growth stage with a control group.

In the control group, the different crops are treated with a standard white light treatment in which fluorescent grow lights are used. In particular, the predetermined lighting parameters are determined by evaluating the following figures of merits and/or characteristics:
plant cycle time (i.e., seedling-to-harvest time), lower plant cycle time being preferable over higher plant cycle time;
fresh weight of plants, measured by weighing fresh plants on a semi-analytical balance, higher fresh weight being preferable over lower fresh weight;
dry weight of plants, measured by weighing crops on a semi-analytical balance after drying, higher dry weight being preferable over lower dry weight;
visual counting of the number of leaves (if the plants do not have clearly discernable, countable leaves, such as in case of glasswort, counting of leaves may be replaced by determination of the stem length, node number, and the number of side branches on the main stem), a higher number of leaves being preferable over a lower number of leaves;
determination of the relative chlorophyll content by means of spectral analysis by means of a SPAD 502 Plus Chlorophyll Meter, a higher relative chlorophyll content being preferable over a lower relative chlorophyll concentration;
determination of the concentration of various minerals in the plants, the minerals being Ca, K, Mg, P, Na, Cu, Fe, Mn, and Zn, a higher concentration of minerals being preferable over a lower concentration of minerals;
determination of the concentration of vitamin A and vitamin C using High Performance Liquid Chromatography (HPLC), a higher concentration of vitamins being preferable over a lower concentration of vitamins; and,
determination of the total carotenoid concentration, a higher concentration of carotenoids being preferable over a lower concentration of carotenoids.

The predetermined growth conditions are determined in three iterations in which the wavelengths used in the light treatments are varied within a limited range in order to optimize plant growth. In particular, the wavelength of the light emitted by the blue LEDs is varied between at least 450 nm and at most 480 nm, the wavelength of light emitted by the green LEDs is kept constant around about 510 nm, the wavelength emitted by the red LEDs is varied between at least 630 nm to at most 660 nm, and the wavelength emitted by the UV LEDs is kept constant at about 320 nm.

In particular, the predetermined light spectrum and/or light intensity is selected as corresponding to the most effective light treatment for enhancing crop growth. Also, the most cost effective light treatment is selected by taking into account the cost as a function of harvest time and the quality of the plants (e.g. as determined by the concentration of pharmacologically active compounds in the plants).

### Example 9: Determining Predetermined Nutrient Concentrations

The present example relates to an exemplary method of determining predetermined parameters of the growth medium, in particular predetermined nutrient concentration. Starting from generic standard nutrient mixes, nutrient uptake for selected plants is monitored using predetermined lighting conditions, and a predetermined water supply for the selected plants. A minimum of ten plants per plant species are used and three biological repeats are performed.

The impact of the nutrient concentration in the growth medium during crop growth is evaluated by comparing crops at the end of the growth stage with a control group. In the control group, the different crops are treated with a standard nutrient mixture. In particular, the predetermined nutrient concentrations are determined by means of the following figures of merits and/or characteristics:
plant cycle time (i.e., seedling-to-harvest time), lower plant cycle time being preferable over higher plant cycle time;
fresh weight of plants, measured by weighing fresh plants on a semi-analytical balance, higher fresh weight being preferable over lower fresh weight;
dry weight of plants, measured by weighing crops on a semi-analytical balance after drying, higher dry weight being preferable over lower dry weight;
visual counting of the number of leaves (if the plants do not have clearly discernable, countable leaves, such as in case of glasswort, counting of leaves may be replaced by determination of the stem length, node number, and the number of side branches on the main stem), a higher number of leaves being preferable over a lower number of leaves;
determination of the relative chlorophyll content by means of spectral analysis by means of a SPAD 502 Plus Chlorophyll Meter, a higher relative chlorophyll content being preferable over a lower relative chlorophyll concentration;
determination of the concentration of various minerals in the plants, the minerals being Ca, K, Mg, P, Na, Cu, Fe, Mn, and Zn, a higher concentration of minerals being preferable over a lower concentration of minerals;
determination of the concentration of vitamin A and vitamin C by HPLC, a higher concentration of vitamins being preferable over a lower concentration of vitamins; and,
determination of the total carotenoid concentration, a higher concentration of carotenoids being preferable over a lower concentration of carotenoids.

Nutrient uptake is determined as a function of time. Based on nutrient uptake profiles, the optimum concentration of macro- and micronutrients is identified.

In addition, further growth medium optimization is carried out in which the optimum concentration of chelates, minerals, peroxide concentration, and sodium chloride in the growth medium is determined.

### Example 10: Determining Predetermined Atmospheric Conditions

The present example relates to determining predetermined atmospheric conditions; i.e. humidity, CO₂ concentration, air flow and the like. In particular, the predetermined carbon dioxide concentration, oxygen concentration, air temperature, and humidity are determined according to the following procedure.

First, standard atmospheric conditions which are appropriate for a specific plant species are taken as an initial value. These standard atmospheric conditions may be obtained from literature. In a sequence of experiments, plants are grown in atmospheres having different temperatures and comprising varying amounts of carbon dioxide, oxygen, and/or humidity. During the experiments, various characteristics pertaining to the microclimate around the plants in the growth chamber are measured by means of appropriate sensors.

In particular, the following characteristics are measured: leaf temperature, stomatal opening, harvest time, fresh weight, dry weight, leaf number, leaf area, vapor pressure deficiency, photosynthesis (measured by using a portable photosynthesis and fluorescence system: LI-6400XT), PAR irradiance, temperature, CO₂ concentration, air speed, and humidity.

These characteristics such as harvest time, fresh weight, dry weight, leaf number, and leaf area are characteristic for the effectiveness of the plant growth conditions. Based on these figures of merit and/or characteristics as a function of atmospheric growth conditions, optimum atmospheric growth conditions are selected as predetermined atmospheric growth conditions.

1. Industrial plant growing facility (100) for growing plants of at least one plant species comprising:
a housing (110) enclosing a growth chamber;
a plurality of racks (120) positioned in the growth chamber, wherein each rack is configured for receiving one or more trays (130);
a plurality of trays (130) placed in the plurality of racks (120), the plurality of trays (130) being configured for receiving a plurality of plants of the at least one plant species, and the plurality of trays (130) being configured for receiving a growth medium;
a fluidic system configured for providing the trays (130) with a growth medium comprising nutrients and having a pH, wherein the fluidic system is configured for adapting the nutrient concentration and pH according to a predetermined nutrient concentration and predetermined pH for the plant species;
a climate system configured for providing a temperature and humidity within the growth chamber, wherein the climate system is configured for adapting the temperature and humidity within the growth chamber according to a predetermined temperature and predetermined humidity for the plant species;
a plurality of light-emitting diode (LED)-based lighting devices (160) configured for providing a light spectrum and a light intensity, wherein the light spectrum comprises photosynthetically active radiation (PAR); and wherein the LED-based lighting devices (160) are configured for adapting the light intensity and/or light spectrum according to a predetermined light intensity and/or predetermined light spectrum for the plant species;
a carbon dioxide system configured for providing a carbon dioxide concentration within the growth chamber, wherein the carbon dioxide system is configured for adapting the carbon dioxide concentration according to a predetermined carbon dioxide concentration for the plant species; and,
a transport system (200) for transporting the trays (130).

2. The industrial plant growing facility (100) according to claim 1, wherein the industrial plant growth facility (100) is configured for adapting the vertical distance between the LED-based lighting devices (160) and the trays (130); and/or wherein the industrial plant growing facility (100) further comprises a light diffuser adapted for homogenising the light emanating from the LED-based lighting devices (160).

3. The industrial plant growing facility (100) according to claim 1 or 2, further comprising a control unit configured for
receiving information about the plant species of the plants in a tray, and controlling the transport system (200) to move the tray to a predetermined position in the rack (120);
receiving information about the nutrient concentration measured in the growth medium; and controlling the fluidic system to adapt the nutrient concentration of the growth medium to a predetermined nutrient concentration;
receiving information about the pH measured in the growth medium; and controlling the fluidic system to adapt the pH of the growth medium to a predetermined pH;
receiving information about the temperature measured in the growth chamber; and controlling the climate system to adapt the temperature in the growth chamber to a predetermined temperature;
receiving information about the humidity measured in the growth chamber; and controlling a climate system to adapt the humidity in the growth chamber to a predetermined humidity;
controlling the LED-based lighting devices to provide a predetermined light spectrum and a predetermined light intensity;
receiving information about the carbon dioxide concentration measured in the growth chamber; and controlling the carbon dioxide system to adapt the carbon dioxide concentration in the growth chamber to a predetermined carbon dioxide concentration; and
optionally controlling the vertical inter-tray distance to a predetermined vertical inter-tray distance;
wherein the predetermined nutrient concentration, the predetermined pH, the predetermined temperature, the predetermined humidity, the predetermined light spectrum, the predetermined light intensity, the predetermined carbon dioxide concentration, and optionally the predetermined vertical inter-tray distance, are determined by the plant species.

4. The industrial plant growing facility (100) according to any one of claims 1 to 3, wherein each rack (120) comprises at least 6 layers (121).

5. The industrial plant growing facility (100) according to any one of claims 1 to 4, wherein the LED-based lighting device (160) comprises a UV LED, a blue LED, a green LED, and a red LED;
the UV LED being configured for emitting light having a wavelength of at least 100 nm to at most 400 nm, preferably for emitting light having a wavelength of at least 300 nm to at most 350 nm;
the blue LED being configured for emitting light having a wavelength of at least 400 nm to at most 490 nm, preferably for emitting light having a wavelength of at least 450 nm to at most 490 nm;
the green LED being configured for emitting light having a wavelength of at least 490 nm to at most 570 nm, preferably for emitting light having a wavelength of at least 500 nm to at most 520 nm; and
the red LED being configured for emitting light having a wavelength of at least 570 nm to at most 700 nm, preferably for emitting light having a wavelength of at least 600 nm to at most 650 nm;
wherein the LED-based lighting device is configured for adapting the light intensity and/or light spectrum emitted by the UV LED, the blue LED, the green LED, and the red LED according to a predetermined light intensity and/or light spectrum for the plant species,
preferably wherein the LED-based lighting device (160) further comprises a far-red LED, the far-red LED being configured for emitting light having a wavelength of at least 700 nm to at most 850 nm, more preferably the far-red LED being configured for emitting light having a wavelength of at least 700 nm to at most 750 nm, the LED-based lighting device being configured for adapting the light intensity emitted by the far-red LED according to a predetermined light intensity.

6. The industrial plant growing facility (100) according to any one of claims 1 to 5, wherein the industrial plant growing facility (100) is configured for providing at least two growth zones, wherein the at least two growth zones have at least a different temperature and/or a different carbon dioxide concentration; preferably wherein the at least two growth zones are located in a vertical region of the growth chamber.

7. A LED-based lighting device (160) for an industrial plant growing facility comprising a UV LED, a blue LED, a green LED, and a red LED;
the UV LED being configured for emitting light having a wavelength of at least 100 nm to at most 400 nm, preferably for emitting light having a wavelength of at least 300 nm to at most 350 nm;
the blue LED being configured for emitting light having a wavelength of at least 400 nm to at most 490 nm, preferably for emitting light having a wavelength of at least 450 nm to at most 490 nm;
the green LED being configured for emitting light having a wavelength of at least 490 nm to at most 570 nm, preferably for emitting light having a wavelength of at least 500 nm to at most 520 nm; and
the red LED being configured for emitting light having a wavelength of at least 570 nm to at most 700 nm, preferably for emitting light having a wavelength of at least 600 nm to at most 650 nm;
wherein the LED-based lighting device is configured for adapting the light intensity and/or light spectrum emitted by the UV LED, the blue LED, the green LED, and the red LED according to a predetermined light intensity and/or light spectrum.

8. The LED-based lighting device according to claim 7, further comprising a far-red LED, the far-red LED being configured for emitting light having a wavelength of at least 700 nm to at most 850 nm; preferably for emitting light having a wavelength of at least 700 nm to at most 750 nm; wherein the LED-based lighting device is configured for adapting the light intensity emitted by the far-red LED according to a predetermined light intensity.

9. A method for growing plants of at least one plant species, comprising the steps of:
(a) providing an industrial plant growing facility (100) according to any one of claims 1 to 6;
(b) placing a tray (130) comprising seeds of the at least one plant species in the growth chamber;
(c) growing the seeds into mature plants, thereby obtaining mature plants; and,
(d) removing the tray (130) comprising the mature plants out of the growth chamber;
wherein during step (c) the nutrient concentration, the pH, the temperature, the humidity, the light spectrum, the light intensity, the carbon dioxide concentration, and optionally the vertical inter-tray distance, are adapted to a predetermined nutrient concentration, a predetermined pH, a predetermined temperature, a predetermined humidity, a predetermined light spectrum, a predetermined light intensity, a predetermined carbon dioxide concentration, and optionally a predetermined vertical inter-tray distance, determined by the plant species.

10. The method according to claim 9, wherein the predetermined nutrient concentration, the predetermined pH, the predetermined temperature, the predetermined humidity, the predetermined light spectrum, the predetermined light intensity, the predetermined carbon dioxide concentration, and optionally the predetermined vertical inter-tray distance, are further determined by the light interval, the growth stage, and/or the desired properties of the mature plants.

11. The method according to claim 9 or 10, wherein
the plant species is a plant species belonging to the group of leafy greens, herbs, halophytes, or medicinal plants;
the light interval of the plant species is the day interval of the day-night cycle or the night interval of the day-night cycle;
the growth stage is the germination stage or the seedling-to-harvest stage, preferably wherein the germination stage lasts at least two days to at most three weeks, preferably wherein the seedling-to-harvest stage lasts at least 11 days to at most 713 days, more preferably at least 20 days to at most 100 days, for example 50 days; and/or,
the desired properties of the mature plants comprise the taste of the mature plants, the colour of the mature plants, and the shape of the mature plants.

12. The method according to any one of claims 9 to 11, wherein the step (c) is performed in at least two growth zones, wherein the at least two growth zones have at least a different temperature and a different carbon dioxide concentration; preferably wherein the at least two growth zones are located in a vertical region of the growth chamber, and/or preferably wherein
the at least two growth zones are adapted to growing plants of different plant species; and/or
the at least two growth zones are adapted to growing plants at different stages of plant growth.

13. The method according to any one of claims 9 to 12, comprising the steps:
(e) repeating step (b) multiple times, wherein at least two trays (130) comprise plants of at least two different plants species;
(f) executing step (c) for the at least two trays (130) provided in step (e); and,
(g) repeating step (d) multiple times, wherein the at least two trays (130) provided in step (e) are removed out of the growth chamber.

14. The method according to any one of claims 9 to 13, comprising the steps:
(h) repeating step (b) a number (n) of times, wherein the trays (130) comprise plants of one plant species, the average time between two consecutive repetitions of step (b) being one n^{th} of the days to harvest the one plant species;
(j) executing step (c) for the trays (130) provided in step (h), wherein the predetermined nutrient concentration, the predetermined pH, the predetermined temperature, the predetermined humidity, the predetermined light spectrum, the predetermined light intensity, the predetermined carbon dioxide concentration, and optionally the predetermined vertical inter-tray distance, are determined by the growth stage of the plants;
(k) repeating step (d) n times, wherein the trays provided in step (h) are removed out of the growth chamber.

15. Use of an industrial plant growing facility according to any one of claims 1 to 6, for growing leafy greens, herbs, halophytes, and/or medicinal plants.

16. Use of a LED-based lighting device according to claim 7 or 8, for growing leafy greens, herbs, halophytes, and/or medicinal plants.
